(19) United States
(12) Patent Application Publication
(10) Pub. No.: US 2007/0171287 A1
(43) Pub. Date: Jul. 26, 2007

(54) Image enlarging device and program

(76) Inventor: Satoru Takeuchi, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 11/579,980

(22) PCT Filed: May 12, 2005
(86) PCT No.: PCT/JP05/08707

§ 371 Date: Nov. 9, 2006

(30) Foreign Application Priority Data
May 12, 2004 (JP) 2004-142841

(51) Int. Cl. H04N 5/262

(52) U.S. Cl. 348/240.99

(57) ABSTRACT

An image input unit (10) receives input of a low-resolution image file. An edge detection unit (12) detects an edge in the low-resolution image. A number of continuously differentiable times estimation unit (14) calculates the Lipchitz exponent (corresponding to the number of continuously differentiable times). An interpolation function selection unit (16) selects an interpolation function (Fluency function) according to the Lipchitz exponent calculated by the number of continuously differentiable times estimation unit (14). An interpolation processing execution unit (18) performs interpolation processing according to the interpolation function selected. An image output unit (20) outputs a file of an enlarged image generated by the interpolation. The image enlarging device (100) having this configuration can correctly store edge information without performing iterative calculation.

### FIELD OF THE INVENTION

Present invention regards to an image enlarging device, and a program.

### BACKGROUND OF THE INVENTION

In recent years, demands of printing and displaying the image photographed by cellular phone etc. are increasing. Therefore a high quality image enlarging technology is needed.

“Image enlarging” means the processing of interpolating a new pixel between pixels, and typically the processing was done by using an interpolation function based on a bilinear form or a bicubic method. However, according to the methods using such interpolation functions, there was a problem that the blurring arise in the enlarged image, and the edge information cannot be correctly stored.

Therefore, the image enlarging technique using a wavelet signal restoration theory is proposed (Nakashizu et.al, in Institute of Electronics, Information and Communication Engineers paper magazine, vol.J-81-DII, pp. 2249-2258, October 1998, (in Japanese). In this technique, the Lipchitz exponent on the outline of an original image is estimated from the multi-scale luminosity slope of the original image, and based on the estimated result, a constraints to the multi-scale luminosity slope of an unknown high resolution image is given. Thus a high resolution image is estimated.

However, according to such image enlarging technique, an iterative operation of huge computational complexity including wavelet transform and inverse transform is necessary in order to store edge information correctly.

Therefore, there is an image enlarging technology interpolating a density value using a two dimensional sampling function (Fluency function), whose function values are equal where the distance from the sampling point in the two dimensional image are the same, is described in JP2000-875865 A.

According to the technology described in the JP2000-875865 A, it is possible to obtain a high definition reconstructed image even when the enlarging processing is performed with small amount of data processing.

By the way, a Fluency function system is defined by a B-spline function system of degree m−1, and the system is a group of functions having different smoothness from a stair shaped (m=1) to a Fourier function (m=infinity). It can be considered that a high quality image enlarging is possible, by selecting an optimal Fluency function according to a feature of the image.

However, according to the technology described in the publication, the degree of the Fluency function, for interpolating the density value of an image, is not selected based on a feature of the image. Moreover, there was no existing prior art describing clearly about the selecting method of the Fluency function, when filing this application.

Therefore, an object of the present invention is to provide an image enlarging device selecting a Fluency function, for interpolating a density value of an image, according to the feature of the image.

### SUMMARY OF THE INVENTION

One aspect of the present invention relates to an image enlarging device. The device includes: an input means for inputting a digital image data describing an image; a detection means for detecting an edge from the digital image data; an estimation means for estimating a number of continuously differentiable times of the edge detected by the detection means; a selection means for selecting an interpolation function based on the number of continuously differentiable times estimated by the estimation means; and an interpolation means for performing a pixel interpolation processing in the edge neighborhood based on the interpolation function selected by the selection means.

Another aspect of the present invention also relates to an image enlarging device. The device includes: an input means for inputting the digital image data describing an image; a detection means for detecting an edge from the digital image data; an operation means for calculating the Lipchitz exponent of the edge detected by the detection means; a selection means for selecting an interpolation function based on a Lipchitz exponent calculated by the operation means; and an interpolation means for interpolating a pixel in the edge neighborhood based on the interpolation function selected by the selection means.

Another aspect of the present invention relates to a program. The program makes a computer to exercise; an edge detecting feature that detects an edge from a digital image data; an estimating feature that estimates the number of continuously differentiable times of the edge detected by the edge detecting feature; a selecting feature that selects an interpolation function based on the number of continuously differentiable times estimated by the estimating feature; and the interpolating feature that interpolates the pixel of the edge area based on the interpolation function selected by the selecting feature.

Another aspect of the present invention also relates to a program. The program makes computer to exercise; a detecting feature that detects an edge from a digital image data; an operating feature that calculates the Lipchitz exponent of the edge detected by the edge detecting feature; a selecting feature that selects an interpolation function based on the Lipchitz exponent calculated by the operating feature; and the interpolating feature that interpolates the pixels in the edge neighborhood based on the interpolation function selected by the selecting feature.

### BRIEF DESCRIPTION OF THE DRAWINGS

FIG. 1 explains an image enlarging when doubling the number of pixels of the image in vertical and horizontal direction.

FIG. 2 shows an example of an image enlarging procedure.

FIG. 3 shows Lipchitz exponents estimated for each pixel (x, y) of a Lena image.

FIG. 4 shows an example of a relation between the Lipchitz exponent and a Fluency interpolation function for selection.

FIG. 5 shows the size of support of a Fluency function.

FIG. 6 shows sampling points etc. of Fluency functions.

FIG. 7 shows functional blocks of an image enlarging device 100.

FIG. 8 shows a configuration of a computer device 200.

FIG. 9 shows a configuration of a camera 300.

FIG. 10 shows a Lena image having 256 pixels in the vertical and horizontal direction.

FIG. 11 shows an original image, which consists of pixels near an eye in the Lena image of FIG. 10. The original image has 32 pixels in the vertical and horizontal direction.

FIG. 12 is an image, having 63 pixels in the vertical and horizontal direction, which is enlarged and generated from the image of FIG. 11.

FIG. 13 is a flow chart showing a flow of a whole enlarging processing in the first example.

FIG. 14 shows pixels interpolated by STEP S20 of FIG. 13, and the pixels interpolated by STEP S30 of FIG. 13.

FIG. 15 is a flow chart showing a procedure of an enlarging processing in the horizontal direction (STEP S20).

FIG. 16 is a flow chart showing a procedure of a selection processing of the interpolation function (STEP S207).

FIG. 17 shows pixels in the original image having a horizontal wavelet transformation coefficient beyond a predetermined value.

FIG. 18 shows an example of interpolated pixels where the Fluency function of m=1 or m=2 is selected.

FIG. 19 is a flow chart showing a detailed procedure of an enlarging processing in the vertical direction (STEP S30).

FIG. 20 is a flow chart showing a procedure of an selection processing of an interpolation function (STEP S307).

FIG. 21 shows pixels of an original image having a vertical wavelet transformation coefficient beyond a predetermined value.

FIG. 22 shows an example of interpolated pixels where Fluency function of m=1 or m=2 is selected.

FIG. 23 shows enlarged images generated by various techniques.

FIG. 24 shows a quality evaluation result of the enlarged images generated by various techniques.

FIG. 25 explains an interpolation when a diagonal edge exists in the position of an interpolating pixel.

FIG. 26 is a flow chart showing a procedure of an enlarging processing in the second example.

FIG. 27 is a flow chart showing a procedure of an interpolation processing of STEP S612.

FIG. 28 is a flow chart showing a procedure of an interpolation processing based on original pixels on the right and left sides.

FIG. 29 is a flow chart showing a procedure of an interpolation processing based on original pixels on the upper and lower sides.

FIG. 30 is a flow chart showing a procedure of an interpolation processing based on original pixels in the 45 degrees diagonal direction.

FIG. 31 is a flow chart showing a procedure of an interpolation processing based on original pixels in the 135 degrees diagonal direction.

### DETAILED DESCRIPTION OF THE PREFERRED EMBODIMENTS

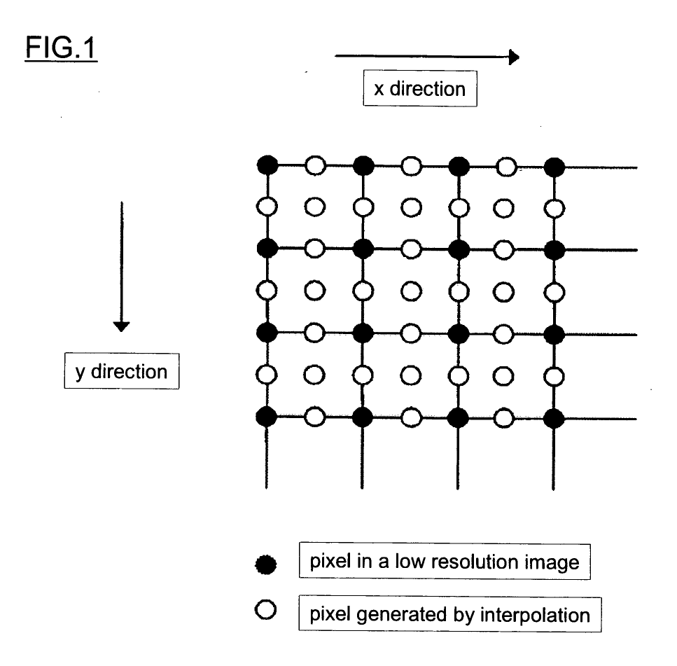

Referring to FIG. 1, an image enlarging, which doubles the number of pixels in both the vertical and horizontal direction, is described hereafter. A black dot of FIG. 1 is a pixel in the image before enlarging. Hereafter, an image before enlarging is called “original image” and a pixel of the image before enlarging is called “original pixel”. A white dot of FIG. 1 is a pixel obtained by enlarging processing, i.e. interpolation between the original pixels and hereafter it is called “interpolation pixel.”

Here, a coordinate system expressing a position of each pixel is the coordinate system based on an image after enlarging. The x and y coordinates of original pixels are assumed to be even numbers.

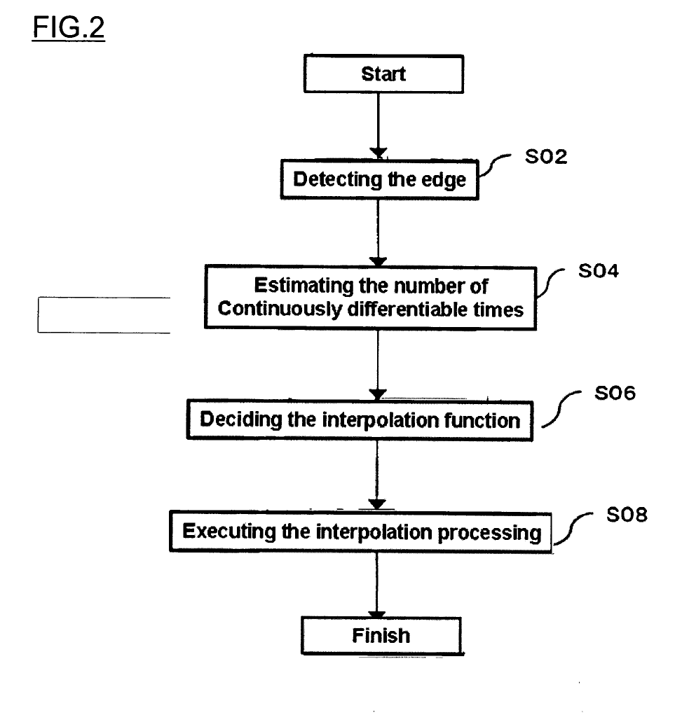

FIG. 2 shows an example of an image enlarging procedure.

In a STEP S02, detection processing of an edge coordinate is performed. There are various methods for detecting an edge coordinates, for example, first calculating the wavelet transform coefficient in each pixel, and then regarding the pixel where the coefficient is beyond a predetermined value as an edge. In a STEP S04, the number of continuously differentiable times at the edge pixel of the original image, detected in S02, is estimated.

For example, the number of continuously differentiable times is estimated based on a Lipchitz exponent in the edge pixel. In a STEP S06, an interpolation function corresponding to the number of continuously differentiable times estimated in the S04 is selected. For example, a Fluency function system is selected as the interpolation function. In a STEP S08, the luminance value of the interpolation pixel is generated based on the interpolation function selected in S06.

In the following, a detail of processing in each of STEPS S02 to S08 is explained.

(STEP S02: Edge Coordinates Detecting Processing)

In the edge coordinates detecting processing of STEP S02, the wavelet transform coefficient in each original pixel is calculated, and when the coefficient is beyond a predetermined value, it is assumed that there is an edge in the position. In the following, its principle is described.

According to a reference (Nakashizu et.al, in Institute of Electronics, Information and Communication Engineers paper magazine, vol.J-81-DII, pp. 2249-2258, October 1998, (in Japanese)), the one dimensional discrete binary wavelet transform is defined by a convolution computation of a signal f(x) and a wavelet basis function ψj(x) as EQ.1:
Wⱼ(ƒ(x))=ψⱼ*ƒ(x) [EQ. 1]

The wavelet basis function is derived as EQ.2 from the basic wavelet function ψ(x). Here, j is a positive integer and it expresses a scale of the wavelet basis function:

$${ψ}_{j} ( x ) = \frac{1}{{2}^{j}} ψ ( \frac{x}{{2}^{j}} ) \qquad [ EQ . 2 ]$$

The signal f(x) is described by wavelet transform (Wj(x)) j∈Z. In an actual numerical computation, since it is impossible to calculate the wavelet transform which is infinitely small, a scaling function φ(x) is introduced and the minimum scale is set to one.

A scaling function scaled by jth power of two is defined as EQ.3, and the signal f(x) smoothed by the scaling function is defined as EQ.4, respectively:

$$\begin{matrix}{ϕ}_{j} ( x ) = \frac{1}{{2}^{j}} ϕ ( \frac{x}{{2}^{j}} ) & [ EQ . 3 ] \\ {S}_{j} ( f ( x ) ) = {ϕ}_{j} * f ( x ) & [ EQ . 4 ]\end{matrix}$$

The smoothed signal Sj(f(x)) of scale 2j is described by two signals; a wavelet transform coefficient Wj+1(x), and a smoothed signal Sj+1(x) of scale 2j+1.

Here, Sj(f(x)) can be reconstructed from a wavelet transform and a smoothed signal by defining a synthetic wavelet basis χ(x) to the wavelet basis function. There is a relation between the synthetic wavelet basis, the wavelet basis, and the scaling function as shown in EQ.5:

$${\vert Φ ( ω ) \vert}^{2} = {\sum }_{j = 1}^{+ ∞} Ψ ( {2}^{j} ω ) X ( {2}^{j} ω ) \qquad [ EQ . 5 ]$$

Here, Φ(ω), Ψ(ω), and X(ω) expresse a Fourier transform of φ(x), ψ(x), and χ(x), respectively.

The smoothed signal Sj(f(x)) is reconstructed as EQ.6:
Sⱼ(ƒ(x))=χⱼ₊₁*Wⱼ₊₁(ƒ(x))+φ^{*}ⱼ₊₁*Sⱼ₊₁(ƒ(x)) [EQ.6]

Here φ(x)*j+1(x) expresses φj+1(−x).

In a two dimensional binary wavelet transform for a two dimensional signal, a smoothed signal Sj(f(x, y)) is defined as EQ.7:
Sⱼ(ƒ(x, y))=φ′ⱼ*ƒ(x, y) [EQ.7]

The smoothed signal is a signal acquired by convolution computations of one dimensional scaling function and the original image in the horizontal and in the vertical direction. A two dimensional scaling function is defined as EQ.8:
φ′ⱼ(x, y)=φⱼ(x)φⱼ(y) [EQ.8]

Two dimensional wavelet transform can be calculated as two elements: i.e. an element obtained by convolving a one dimensional wavelet basis function in the horizontal direction (EQ.9); and the element obtained by convolving the one dimensional wavelet basis function in vertical direction (EQ.10):
Wⱼ¹(ƒ(x, y))=ψⱼ¹*ƒ(x, y) [EQ.9]
Wⱼ²(ƒ(x, y))=ψⱼ²*ƒ(x, y) [EQ.10]

Here, two wavelet basis functions can be described as EQ.11 and EQ.12, respectively:
ψⱼ¹(x, y)=φⱼ₋₁(x)ψⱼ(y) [EQ.11]
ψⱼ²(x, y)=φⱼ₋₁(y)ψⱼ(x) [EQ.12]

When a wavelet basis function corresponds to a first degree differentiation of a smoothing function symmetrical to the origin (EQ.13 and EQ.14), it is known that a square root of the square sum of a horizontal and a vertical wavelet transform (EQ.15) takes the local maximum value in an edge in the image.

$$\begin{matrix}ψ ( x ) = \frac{ⅆ ϕ ( x )}{ⅆ x} & [ EQ . 13 ] \\ ψ ( y ) = \frac{ⅆ ϕ ( y )}{ⅆ y} & [ EQ . 14 ] \\ {M}_{j} ( f ( x , y ) ) = \sqrt{{{W}_{j}^{1} ( f ( x , y ) )}^{2} + {{W}_{j}^{2} ( f ( x , y ) )}^{2}} & [ EQ . 15 ]\end{matrix}$$

The direction of the detected edge can be described as EQ.16:

$$θ ( x , y ) = {tan}^{- 1} \frac{{W}_{j}^{1} ( f ( x , y ) )}{{W}_{j}^{2} ( f ( x , y ) )} \qquad [ EQ . 16 ]$$

(STEP S04: Estimation of a Number of Continuously Differentiable Times)

In a STEP S04, estimation of a number of continuously differentiable times at the edge pixel in the original image detected in S02 is performed. Here, the number of continuously differentiable times is estimated by calculating a Lipchitz exponent in the edge pixel.

According to a reference: “Mallet et.al, “Singularity detection and processing with wavelets” IEEE Trans.Inf.Theory, vol. 38, pp. 617-643, March 1992”, each value of the multi-scale luminosity slope plane M(f(x, y)) can be described as EQ.17, having a certain K satisfying K>0, when the scale parameter j is small enough:
Mⱼ(ƒ(x, y))=K×2^{jα} [EQ.17]

Each value of the two dimensional wavelet transform W1(f(x, y)) can be described as EQ.18, having a certain K1 satisfying K1>0, when the scale parameter is small enough. Each value of the two dimensional wavelet transform W2(f(x, y)) can be described as EQ.19, having a certain K2 satisfying K2>0, when the scale parameter is small enough.
Wⱼ¹(ƒ(x,y))=K₁×2^{jα} [EQ.18]
Wⱼ²(ƒ(x, y))=K₂×2^{jα} [EQ.19]

Here, α is called a Lipchitz exponent and the function ƒ is continuously differentiable same time as a maximum integer not exceeding α. Therefore, by calculating the Lipchitz exponent in each edge pixel, it is possible to estimate the number of continuously differentiable times. According to EQ.17, the (two dimensional) Lipchitz exponent at a small enough scale j, and j+1, is estimated as EQ.20:

$${α}_{j}^{j + 1} ( x , y ) = {log}_{2} \frac{{M}_{j + 1} f}{{M}_{j f}} \qquad [ EQ . 20 ]$$

According to EQ.18 and EQ.19, the one dimensional Lipchitz exponents (for horizontal and vertical direction) are estimated as EQ.21 and EQ.22, respectively.

$$\begin{matrix}{α}_{j}^{{1}^{j + 1}} ( x , y ) = {log}_{2} \frac{{W}_{j + 1}^{1} ( f ( x , y ) )}{{W}_{j}^{1} ( f ( x , y ) )} & [ EQ . 21 ] \\ {α}_{j}^{{2}^{j + 1}} ( x , y ) = {log}_{2} \frac{{W}_{j + 1}^{2} ( f ( x , y ) )}{{W}_{j}^{2} ( f ( x , y ) )} & [ EQ . 22 ]\end{matrix}$$

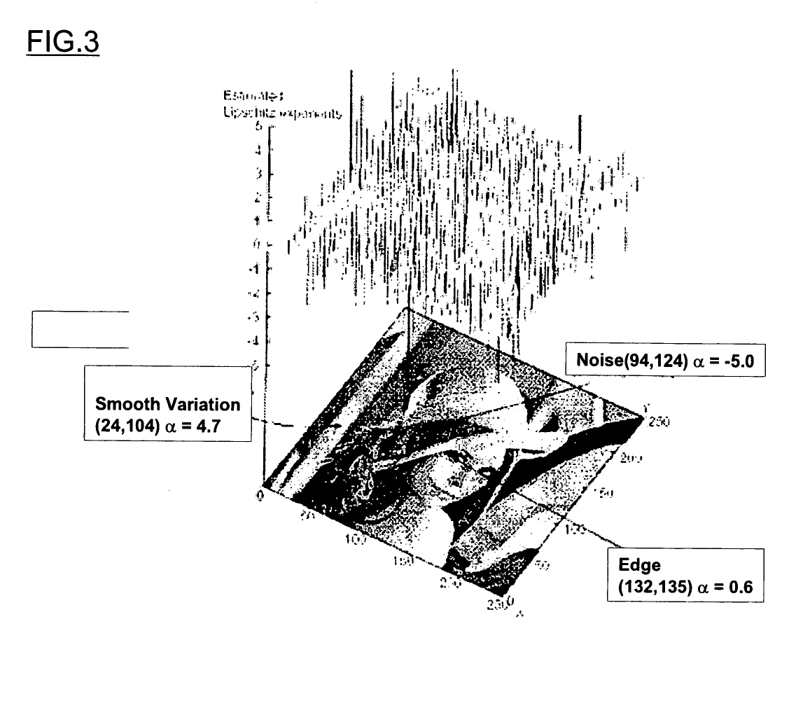

Generally, the Lipchitz exponent becomes large, as a transition of the luminance value becomes smoother. FIG. 3 expresses the Lipchitz exponent estimated for each pixel (x, y) of the Lena image. At a pixel (24, 104), having a smooth transition of a luminance value, the Lipchitz exponent is in a large value of 4.7, and an edge pixel (132, 135), the index is in a small value of 0.6. For a pixel (94, 124), where the direction of an edge cannot be settled, the Lipchitz exponent becomes a negative number (−5.0), and it is distinguished as noise.

(STEP S06: Selection of an Interpolation Function)

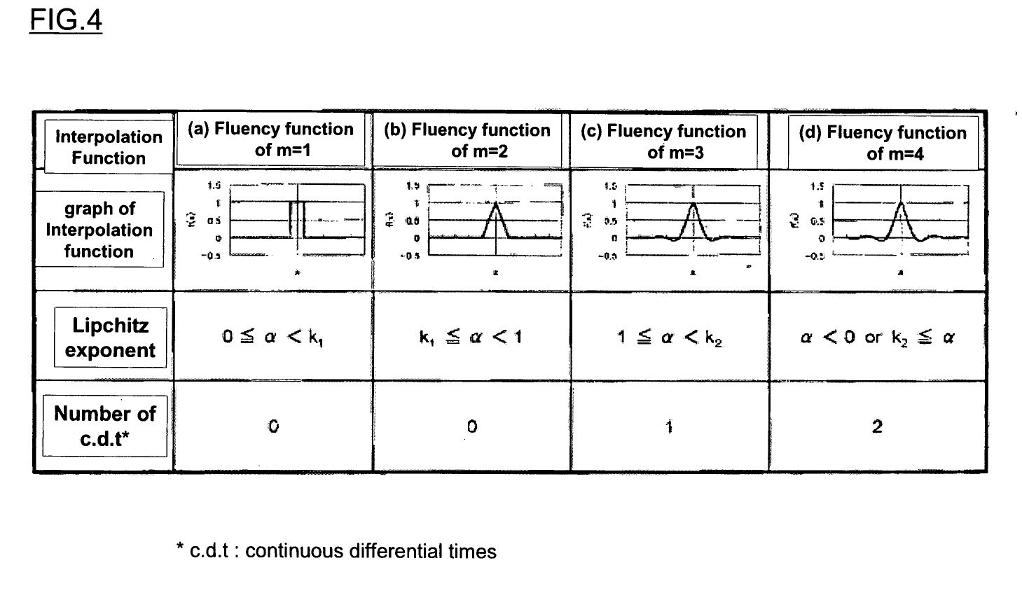

In a STEP S06, an interpolation function is selected based on the number of continuously differentiable times estimated in S04. Concretely, a Fluency function for interpolation is selected based on the Lipchitz exponent α, as shown in FIG. 4.

The fluency theory is known as one of the means for performing a D/A conversion. Traditionally, the typical method of the D/A conversion is to transfer a digital signal to a Fourier signal space, which is limited to an analog band, based on the sampling theorem proposed by Shannon. However, the Fourier signal space, which is a group of infinitely differentiable and continuous signals, has a problem for describing a signal including a discontinuous point or an indifferentiable point. Thus the fluency theory is established in order to perform D/A conversion of a digital signal, including such a discontinuous point or an indifferentiable point, with high precision.

In fluency theory, the signal space mS configured by m−1 degree spline functions is prepared (hereafter the signal space is called “fluency signal space”). According to a reference (Kamata et.al, in Institute of Electronics, Information and Communication Engineers paper magazine, vol. Vol. J71-A1988, (in Japanese)), the sampling base in the fluency signal space mS is described as EQ.23:
{_{[s]}^{m}φₖ}_{K=-∞}^{∞} [EQ.23]

Here:

$$\begin{matrix}{}_{[ s ]}^{m}{ϕ}{}_{k}^{} ≅ {\sum }_{l = - ∞}^{∞} {}^{m} β [ l - k ] {}_{[ b ]}^{m}{ϕ}{}_{l}^{} k = 0 , \pm 1 , \pm 2 , … ; & [ EQ . 24 ] \\ {}_{[ b ]}^{m}{ϕ}{}_{l}^{} ( t ) ≅ {\int }_{- ∞}^{∞} {[ sin ( π fh ) / ( π fh ) ]}^{m} exp ( j2π f ( t - lh ) ) ⅆ f , l = 0 , \pm 1 , \pm 2 , … ; m = 0 , 1 , 2 … ; & [ EQ . 25 ] \\ {}^{m} β [ p ] = h {\int }_{- 1 / 2 h}^{1 / 2 h} {}_{f}^{m} B ( f ) exp ( j2π fph ) ⅆ f , p = 0 , \pm 1 , \pm 2 , … ; & [ EQ . 26 ] \\ {}_{f}^{m} B ( f ) = h / {\{ {\sum }_{q = - ∞}^{∞} [ sin ( π ( fh - q ) ) / π ( fh - q ) ) ]}^{m} \} & [ EQ . 27 ]\end{matrix}$$

Hereafter, the function system described with EQ.28 is called a fluency sampling base at the fluency signal space mS:
{_{[s]}^{m}φₖ}_{k=-∞}^{∞} [EQ.28]

Also, each of the function (see EQ.29) in EQ.28 is called a Fluency function:
_{[s]}^{m}φₖ [EQ.29]

When approximating a signal using the fluency sampling base, a degree parameter m is set according to the character of a target signal. Here, m can be selected from 1 to infinity. The fluency sampling base (see EQ.30) having m=1 to 3 is described as EQ.31 to EQ.33.

$$\begin{matrix}{}_{[ s ]}^{m}{ϕ}{}_{k}^{} & [ EQ . 30 ] \\ {}_{[ s ]}^{1}{ϕ}{}_{k}^{} ( t ) = {h}_{[ b ]}^{1} {ϕ}_{k} ( t ) & [ EQ . 31 ] \\ {}_{[ s ]}^{2}{ϕ}{}_{k}^{} ( t ) = {h}_{[ b ]}^{2} {ϕ}_{k} ( t ) & [ EQ . 32 ] \\ {}_{[ s ]}^{3}{ϕ}{}_{k}^{} ( t ) = \sqrt{2} h {\sum }_{l = - ∞}^{∞} {( - 3 + 2 \sqrt{2} )}^{\vert l - k \vert} {}_{[ b ]}^{3}{ϕ}{}_{l}^{} ( t ) & [ EQ . 33 ]\end{matrix}$$

In addition, in a reference (Toraichi, et.al, in Institute of Electronics, Information and Communication Engineers paper magazine (Vol. 73), September 1990), it is described that a Fluency function corresponds to a sinc function when m is infinity.

As described above, in the fluency theory, a Fluency function can be called a group of functions having a different smoothness from a stairs-like function (m=1) to a sinc function (m=infinity).

Conventionally, the signal processing was done by applying the sampling theorem of Shannon, by setting a zone signal restriction space H based on a global frequency of the signal, and by setting the sampling base as an approximation function of a sinc function as a sampling base. In other words, from a viewpoint of the fluency theory, only the signal space of ∞S was used.

However, a signal may include a local point where it is indifferentiable or the number of continuously differentiable times is finite. The sinc function, which the number of continuously differentiable times is infinite, is unsuitable for processing such a signal.

On the other hand, in the fluency theory, an efficient processing is possible, by setting a parameter m according to the number of continuously differentiable times of the target signal in local, and by selecting the signal space mS suitable for describing the signal.

Referring to FIG. 4 again, the selecting procedure of a Fluency function for interpolation based on a Lipchitz exponent α is explained.

In the present example, an interpolation function is selected among four kinds of functions shown in FIG. 4. The degrees m−1 of the interpolation function (a), (b), (c), and (d) are 0, 1, 2, and 3, respectively, and the number of continuously differentiable times are 0, 0, 1, and 2. Here, the Lipchitz exponent α is estimated using EQ.20 in sufficiently small scales j and j+1.

When both of the original pixels neighboring an interpolation pixel are non-edge coordinates, the function (d) in FIG. 4 (i.e., the Fluency function of Mm=4) is selected. Or instead, a simple bilinear interpolation or bicubic interpolation may be done.

When one of the original pixel neighboring the interpolation pixel is an edge pixel, one function out of functions (a), (b), and (c) (i.e. one out of the Fluency functions of m=1, m=2, and m=3) in FIG. 4 is selected based on the Lipchitz exponent α of the original pixel which is the edge pixel. Here, since the number of continuously differentiable times is 0 for both functions (a) and (b), it is unable to select a function simply by the number. Therefore, the selection criterion parameter k1 (0<k1<1) is set, and the selection between (a) or (b) is determined by whether α is below k or not. For example, when 0<α<=k1, the Fluency function of m=1 is selected as the interpolation function; when k1<α<1, the Fluency function of m=2 is selected as the interpolation function. Moreover, the second selection criterion parameter k2 may be set; when 1<=α<k2; the Fluency function of m=3 may be selected as the interpolation function; when k2<=α, the Fluency function of m=4 may be selected as the interpolation function. Moreover, when α<0, the Fluency function of m=4 may be selected as the interpolation function also.

When α<0, it is known that the luminance information in a corresponding edge is noise. When k2<=α, it is considered that the luminance value of the area varies smoothly (meaning that an edge does not exist). As an example, the parameters k1, k2 are about k1=0.5, and k2=1.75. These parameters are selected, for example, based on the average value of the Lipchitz exponents at edge coordinates in the whole image.

When the original pixels, which are located on both sides of an interpolation pixel, are edge pixels, a Fluency function is selected based on an average value of the Lipchitz exponent α of the neighboring original pixels. Or instead, the Fluency function may be selected based on a Lipchitz exponent α of one of the neighboring original pixels. For example, the Fluency function may be selected based on the larger Lipchitz exponent α among the neighboring original pixels.

(STEP S08: Execution of Interpolation Processing)

In a STEP S08, an interpolation processing is performed based on the Fluency function selected in S06.

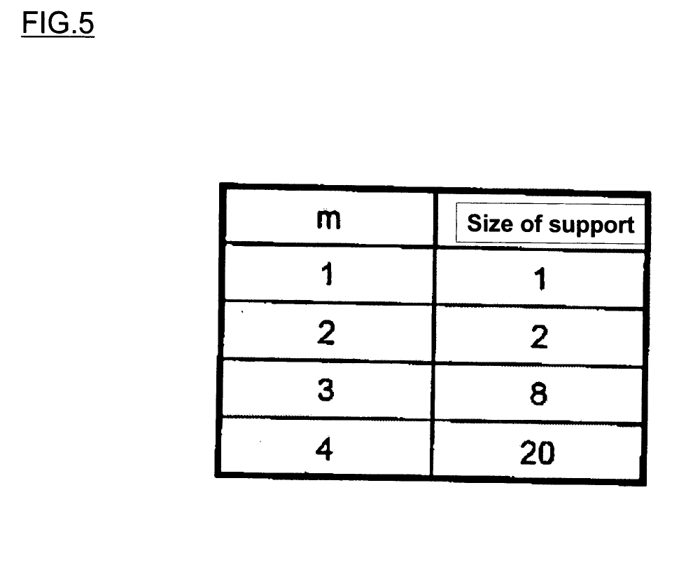

First, the number of points in the original image to be used for the interpolation is determined. The number is dependent on the size of support of each Fluency function. As shown in FIG. 5, each Fluency function has a different size of support. The size of support means the number of sampling points where the value of the function becomes non-zero when a Fluency function is sampled at a predetermined sampling interval. In other words, the size of support corresponds to the number of the neighboring pixels to be referred in the original image in an interpolation processing.

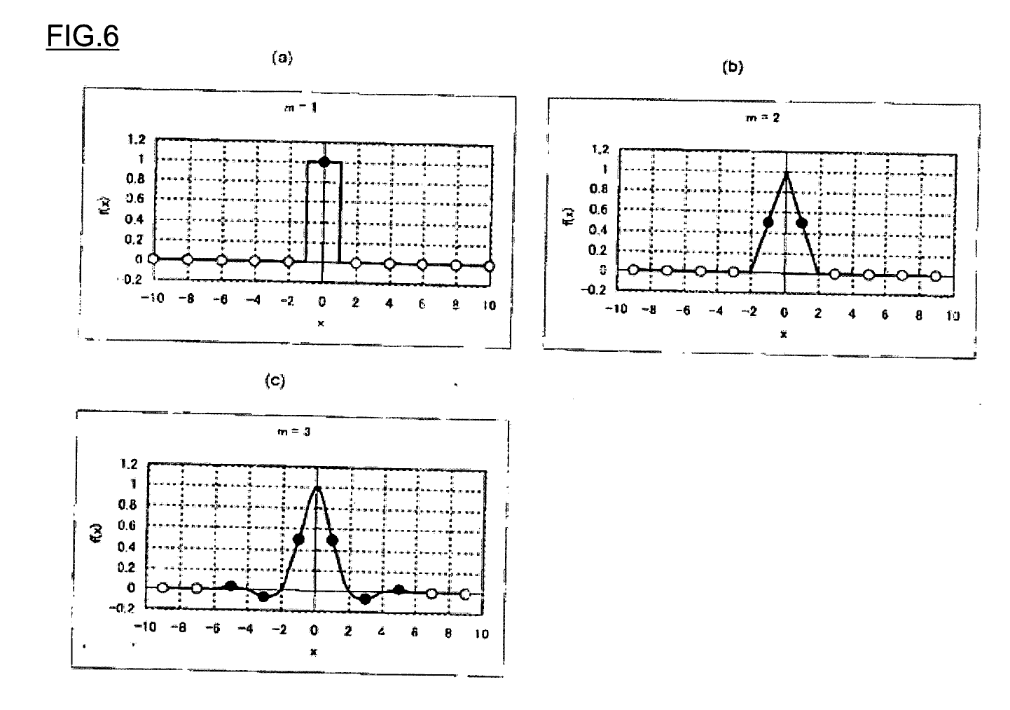

For example, when m=1, the value of the function f(x) at a sampling point where x=0 is 1, but the value of the function f(x) is zero for all other sampling points (points shown in white circle), as shown in FIG. 6A. Therefore, the number of the sampling point having a non-zero function value is 1, and the number of support is 1. In this case, a luminance value I(x) of an interpolation pixel Q(x) is set to the same value as I(x−1), which is the I(x+1)I(x−1)luminance value of the original pixel P(x−1) in the left side of the interpolation pixel Q(x), or I(x+1), which is the luminance value of the original pixel P(x+1) in the right side of the interpolation pixel Q(x)P.

When m=2, the function values f(x) at the sampling points at x=±1 are 0.5, but the function values f(x) are zero in all other sampling points (points shown in white circle), as shown in FIG. 6B. Therefore, the number of the sampling point having a non-zero function value is 2, and the number of support is 2. In this case, a luminance value I(x) of an interpolation pixel Q(x) is determined based on the luminance values of two neighboring original pixels of the interpolation pixel Q(x), i.e. I(x−1) and I(x+1), which are described in EQ.34.
I(x)=ƒ(x−1)*I(x−1)+ƒ(x+1)*I(x+1) [EQ.34]

When m=3, the function values f(x) at sampling points x=±7, ±5, ±3, and ±1, are non-zero, while the function value f(x) are zero in all other sampling points (points shown in white circle), as shown in FIG. 6C. Therefore, the number of support is 8. In this case, a luminance value I(x) of an interpolation pixel Q(x) is determined based on the luminance values of eight neighboring original pixels of the pixel Q(x), i.e. I(x−7), I(x−5), I(x−3), I(x−1), I(x+1), I(x+3), I(x+5), and I(x+7), as described in EQ.35 and EQ.36:

$$\begin{matrix}I ( x ) = {\sum }_{n = - 4}^{n = 3} f ( 2 n + 1 ) * I ( 2 n + 1 ) & [ EQ . 35 ] \\ {\sum }_{n = - 4}^{n = 3} f ( 2 n + 1 ) = 1 & [ EQ . 36 ]\end{matrix}$$

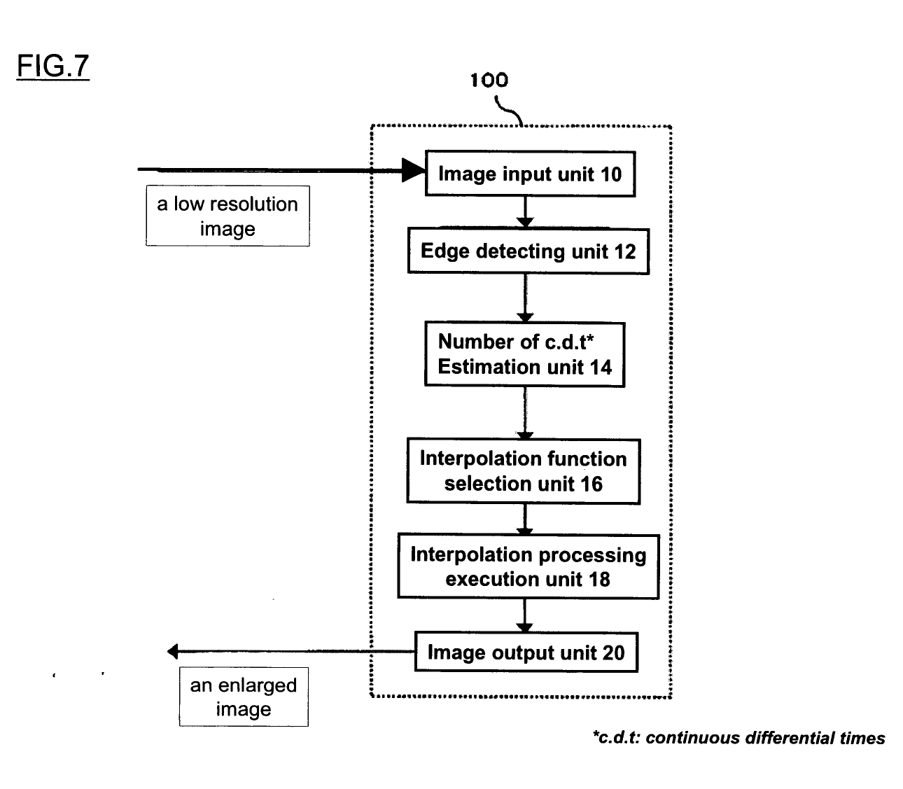

FIG. 7 shows the configuration of an image enlarging device performing the image enlarging explained above. The image enlarging device 100 comprises, an image input unit 10, an edge detection unit 12, a number of continuously differentiable times estimation unit 14, an interpolation function selection unit 16, an interpolation processing execution unit 18, and an image output unit 20.

The image input unit 10 receives input of a low resolution image file. The edge detection unit 12 detects an edge in the low resolution image. The number of continuously differentiable times estimation unit 14 calculates the Lipchitz exponent at an original pixel as mentioned above. The interpolation function selection unit 16 selects an interpolation function (Fluency function) based on the Lipchitz exponent calculated by the number of continuously differentiable times estimation unit 14. The interpolation processing execution unit 18 performs interpolation processing based on the interpolation function selected. The image output unit 20 outputs a file of an enlarged image generated by the interpolation.

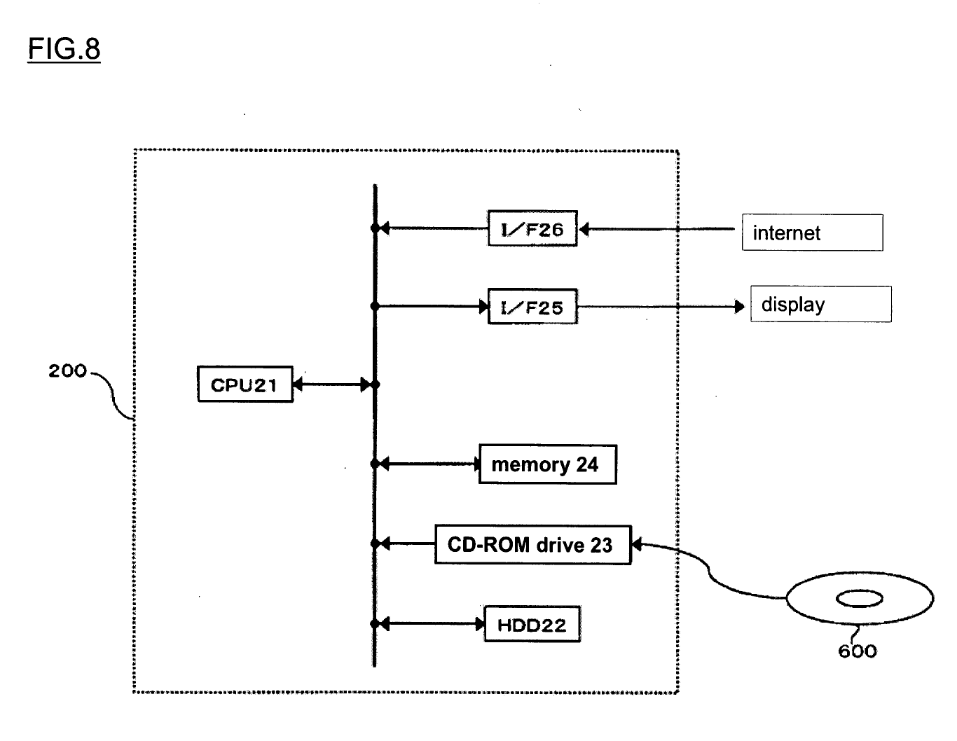

The image enlarging processing described above may be done by CPU 21 of a computer device 200, such as a personal computer, executing a program loaded to a memory 24, as shown in FIG. 8. Or instead, the enlarging processing may be done by CPU 21 of the computer device 200, executing the program stored in a CD-ROM 600 equipped in a CD-ROM drive 23.

This program includes: a STEP S02, for detecting an edge coordinates in a low resolution image acquired from internet via I/F (Inter Face) 25, or from an image stored in a HDD (Hard Disk Drive) 22; a STEP S04, for estimating the number of continuously differentiable times at the edge pixel, detected in STEP S02, of the original picture; a STEP S06, for selecting an interpolation function corresponding to the number of continuously differentiable times estimated in STEP S04; and a STEP S08, for generating a luminance value based on the interpolation function decided in STEP S06. The enlarged image generated in STEP S08 is recorded on a HDD 22, or displayed on a display attached to a computer device 200 via I/F (Inter Face) 24.

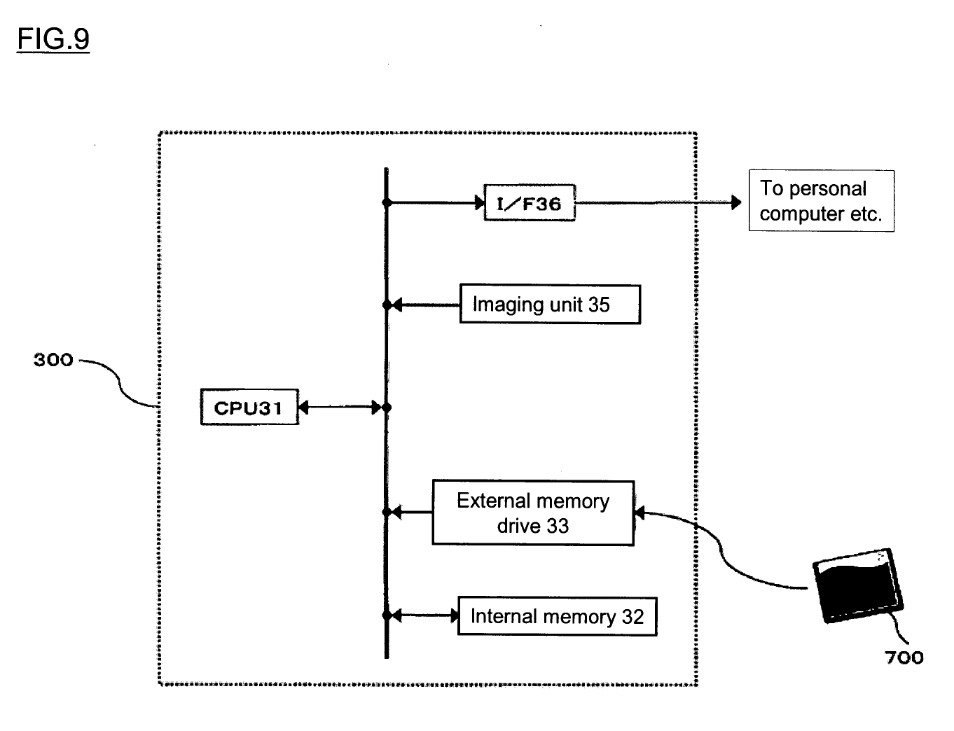

The image enlarging processing described above may be performed by CPU 31 of a camera 300, as shown in FIG. 9, executing a program loaded to the internal memory 32.

This program includes: a STEP S02, for detecting an edge coordinates a low resolution image photographed by an imaging unit 35; a STEP S04, for estimating the number of continuously differentiable times at the edge pixel in the original image, detected in the S02; a STEP S06, for selecting an interpolation function corresponding to the number of continuously differentiable times in S04; and a STEP S08, for generating a luminance value of an interpolation pixel, based on the interpolation function decided in S06. The enlarged image generated in STEP S08 is recorded on a semiconductor memory 700 equipped to an external memory drive 33, or is transmitted to a computer device via I/F 36.

### THE FIRST EXAMPLE

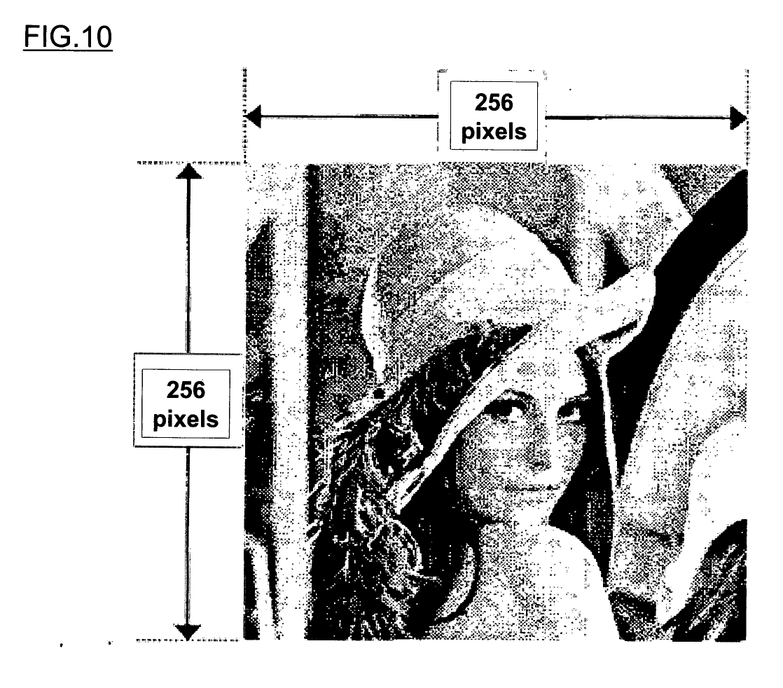

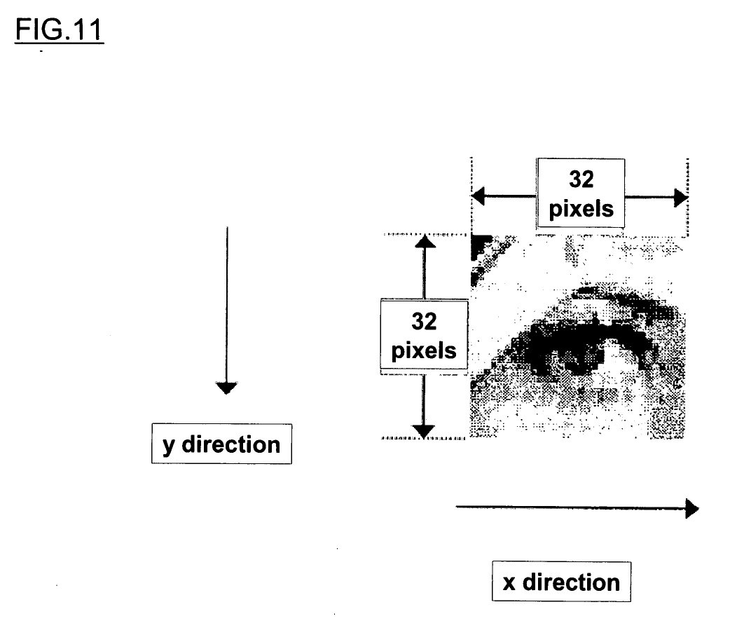

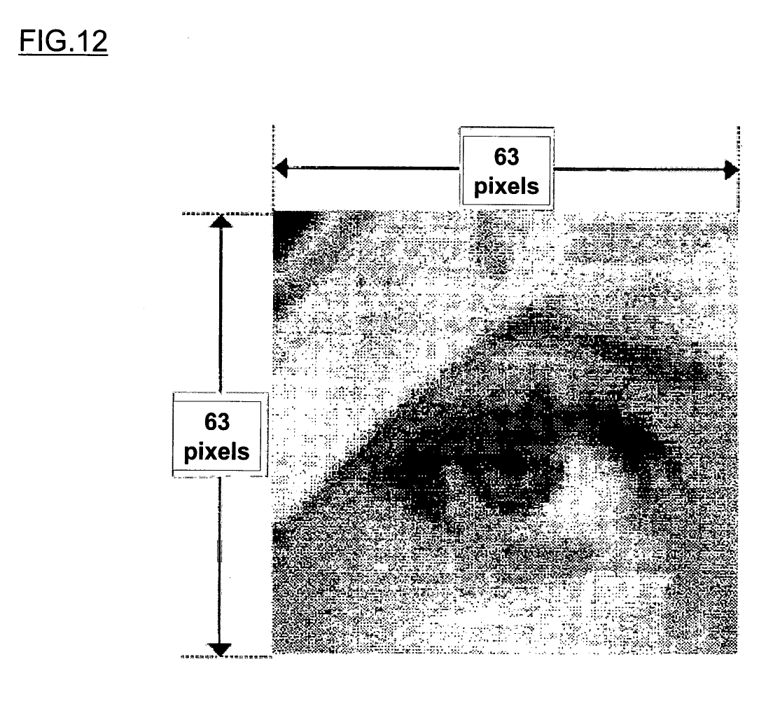

An image enlarging experiment according to the present embodiment is done using a Lena image shown in FIG. 10. Although, the Lena image is configured by 256 pixels in the vertical and horizontal directions, here, it is assumed that the original image is configured by 32 pixels in each direction near the pupil of the Lena image (see FIG. 11), and an example of generating an image having 63 pixels for each direction (see FIG. 12) is described here.

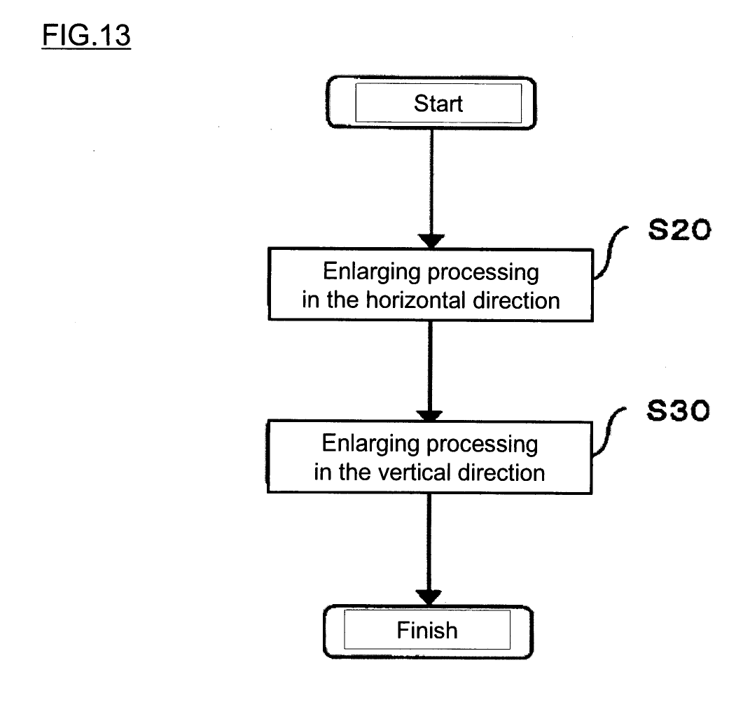

FIG. 13 is a flow chart showing an overall flow of the image enlarging.

First, the enlarging processing in the horizontal direction (x direction of FIG. 11) is performed (STEP S20). In the STEP S20, the luminance value of an interpolation pixel is decided based on a luminance value of the original pixels to the right and left of the interpolation pixel. As a result of such enlarging processing in the horizontal direction, an image having 32 pixels in the vertical direction and 63 pixels in the horizontal direction is generated temporally.

Next, an enlarging processing in the vertical direction (corresponds to y direction in FIG. 11) is performed (STEP S30). As a result, an image having 63 pixels in each direction is generated. In the STEP S30, a luminance value of an interpolation pixel is decided based on the luminance value of the original pixels to the upper and lower sides of the interpolation pixel.

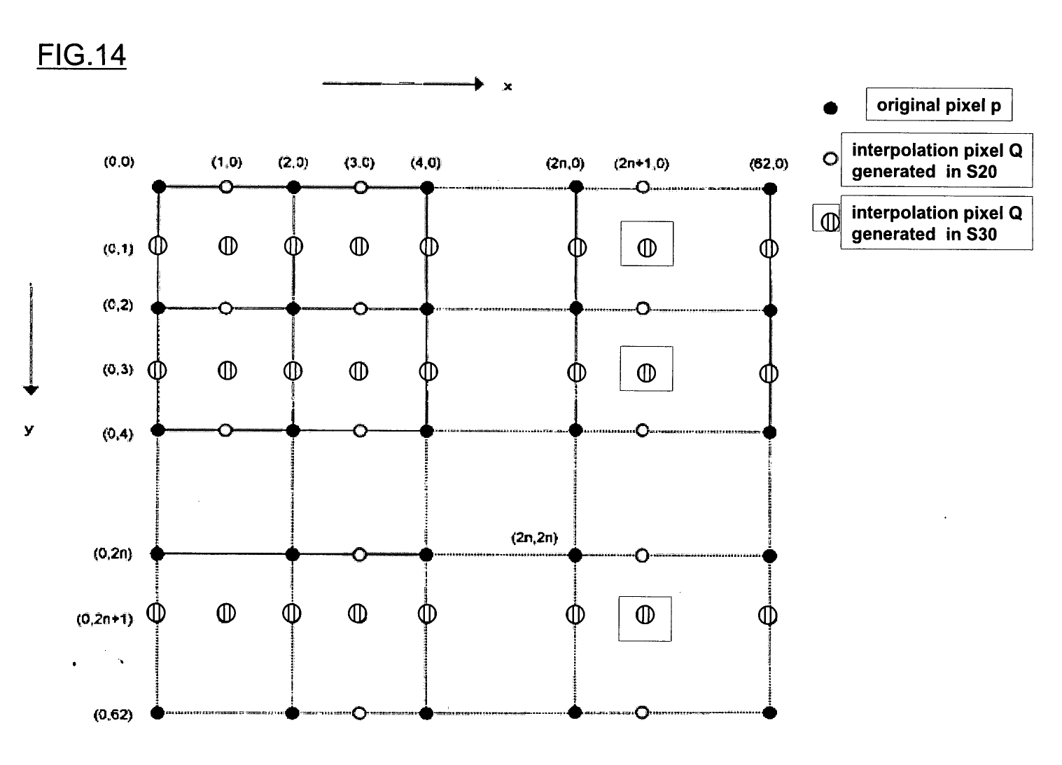

FIG. 14 shows a spatial relationship between original pixels P (pixels in the original image), and interpolation pixels. A black dot shows an original pixel, a white circle shows the interpolation pixel generated in STEP S20, and a slash coated circle shows the interpolation pixel generated in STEP S30. A luminance value array of the enlarged image consisting of such original pixels and interpolation pixels is assumed as f(x,y) (here x and y are integers satisfying 0<=x<=62, 0<=y<=62). In the f(x,y) array, both x-coordinate value and y-coordinate value of the original pixels are set to even numbers. As for the x-coordinate value and the y-coordinate value of the interpolation pixel, at least one is or the both are in odd numbers.

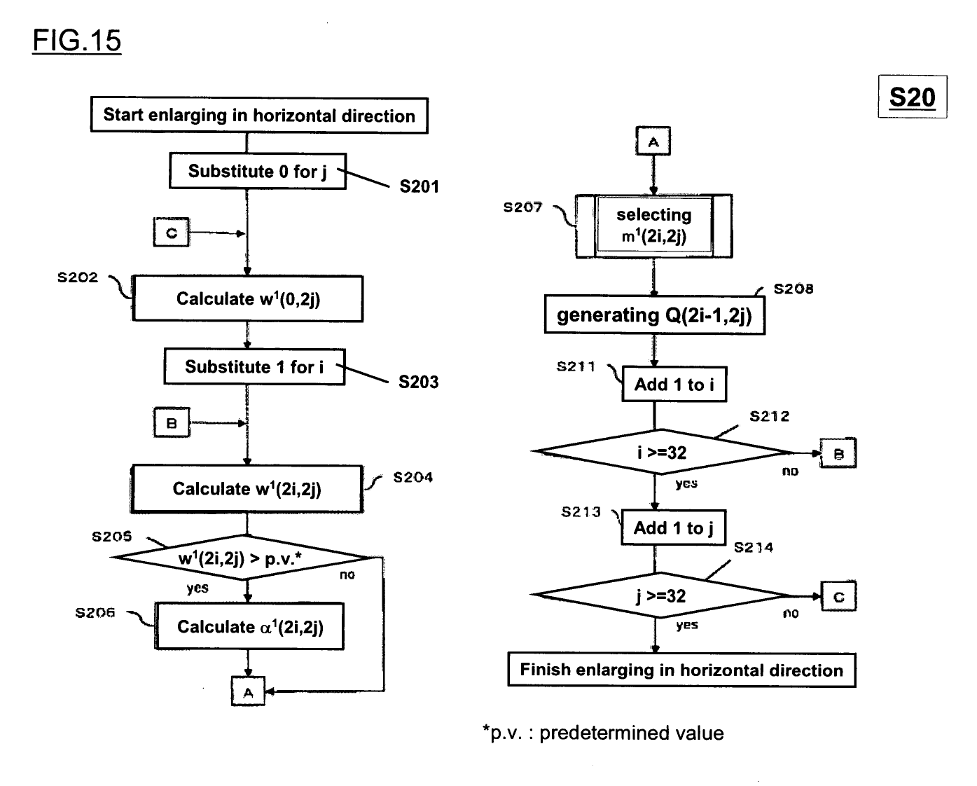

FIG. 15 is a flow chart showing a detailed procedure of an enlarging processing in the horizontal direction (STEP S20).

In a STEP S201, zero is substituted for j. In a STEP S202, a horizontal wavelet transform coefficient W1(0, 2j) in an original pixel P(0, 2j) is calculated.

In a STEP S203, 1 is substituted for i.

In a STEP S204, a horizontal wavelet transform coefficient W1(2i; 2j) in an original pixel P(2i, 2j) is calculated. When i=1 and j=0, a horizontal wavelet transform coefficient W1(2, 0) in an original pixel P(2, 0) is calculated. The original pixel P(2, 0) is an original pixel having a coordinate value of x=2 and y=0. Here, W1(x, y) is acquired by setting j (the scaling parameter) in EQ.9 to 1, and it can be calculated as following.

First, it is assumed that a wavelet-basis function ψj(y) corresponds to EQ.38, which is a primary differentiation of a smoothing function symmetrical to the origin (EQ.37).

$$\begin{matrix}{ϕ}_{j} ( y ) = \frac{1}{\sqrt{{2}^{j} π}} exp ( - \frac{{y}^{2}}{{2}^{j}} ) & [ EQ . 37 ] \\ {ψ}_{j} ( y ) = - \frac{2 y}{\sqrt{{2}^{j} π}} exp ( - \frac{{y}^{2}}{{2}^{j}} ) & [ EQ . 38 ]\end{matrix}$$

Also, it is assumed that the φj−1(x) in EQ.11 corresponds to EQ.39.

$${ϕ}_{j - 1} ( x ) = \frac{1}{\sqrt{{2}^{j - 1} π}} exp ( - \frac{{x}^{2}}{{2}^{j - 1}} ) \qquad [ EQ . 39 ]$$

By substituting EQ.40 in EQ.9, W1(x, y) can be calculated.

$$\begin{matrix}{ψ}_{j = 1}^{1} ( x , y ) = {ϕ}_{0} ( x ) {ψ}_{1} ( y ) \\ = \frac{1}{\sqrt{π}} exp ( - {x}^{2} ) \times ( - \frac{2 y}{\sqrt{2 π}} ) exp ( - \frac{{y}^{2}}{2} )\end{matrix} \qquad [ EQ . 40 ]$$

When W1(2, 0), calculated as above, is beyond a predetermined value (when yes in STEP S205), it is regarded that there is a vertical direction edge in the position of the original pixel P(2, 0).

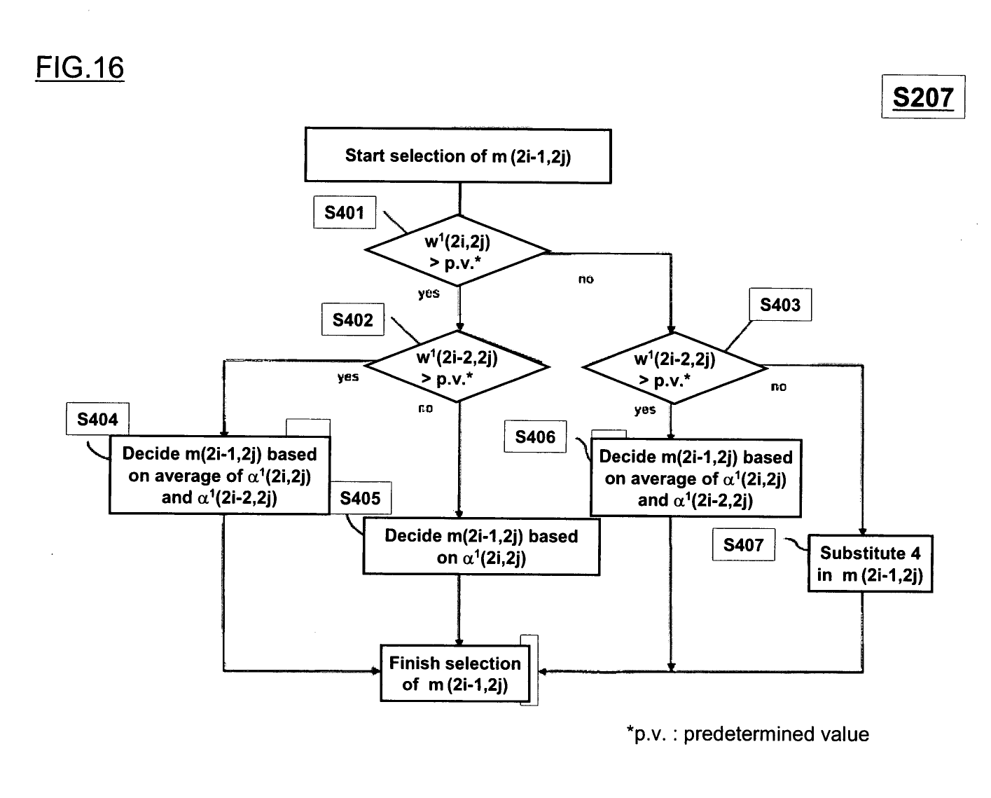

When yes in STEP S205, a Lipchitz exponent α(2, 0) in the original pixel P (2, 0) is calculated (STEP S206). This α(2, 0) is calculated by substituting j=0 in EQ.21. In the continuing STEP S207, an interpolation Fluency function m(1, 0) for generating a luminance value of an interpolation pixel Q(1, 0) located in the left side of P(2, 0) is selected. A selection procedure of the interpolation Fluency function is described in detail later with reference to FIG. 16.

When it is “no” in STEP S20, STEP S206 is skipped and advances to STEP S207.

In STEP S208, an interpolation processing in the horizontal direction is performed. Concretely, based on an interpolation Fluency function m(1, 0) selected in STEP S207, the luminance value of an interpolation pixel Q(1, 0) is generated (STEP S208). The interpolation pixel Q(1, 0) is an interpolation pixel which has coordinate values of x=1 and y=0.

In a STEP S211, 1 is added to the parameter i. In a STEP S212, it is judged whether i is 32 or more. When i is 32 or more (“yes” in STEP S212), it advances to STEP S213.

When it is “no” in STEP S212, it returns to S204 again, and the wavelet transform coefficient etc. on an original pixel P(4, 0) located in the right side of an original pixel P(2, 0) is calculated, and a luminance value of the interpolation pixel Q(3, 0) is generated.

Similarly as above, interpolation pixels in the first line (i.e. Q(5, 0), ---, Q(61, 0)) are generated. When the generation is completed (i.e. yes in the STEP S212), 1 is added to j (STEP S213), then it returns back to STEP S202 via STEP S214. After that, interpolation pixels in the third line (i.e. Q(1, 2), ---, Q(61, 2)) are generated (The generation of interpolation pixels in the second line Q(1, 1), ---, Q(61, 1) are performed in STEP S30 mentioned afterward). Similarly, such interpolation processing is performed until the 32nd line (“yes” in STEP S214).

FIG. 16 shows a procedure of an interpolation Fluency function selection processing of the STEP S207.

In STEP S401, whether W1(2i, 2j) at original pixel P(2i, 2j) is beyond a predetermined value is evaluated. In other words, it is judged whether a vertical direction edge exists in the original pixel P(2i, 2j).

In STEP S402, whether W1(2i−2, 2j) is beyond a predetermined value is evaluated. When the W1(2i−2, 2j) is beyond the predetermined value (yes in STEP S402), an interpolation function for generating the luminance value of an interpolation pixel Q(2i−1, 2j) is selected, based on the average value of α(2i−2, 2j) and α(2i, 2j).

In this case, an edge would exist in original pixels P(2i−2, 2j), and P(2i, 2j), which are on both sides of the interpolation pixel Q(2i−1, 2j). By the way, according to FIG. 15, when W1(2i, 2j) is beyond the predetermined value in STEP S205, the Lipchitz exponent α(2i, 2j) is calculated in a STEP S206. In this case, the Lipchitz exponents α(2i−2, 2j) and α(2i, 2j), which are the indices of both side pixels of the interpolation pixel Q(2i−1, 2j), are already calculated. Therefore, the interpolation function is selected here based on an average value of α(2i−2, 2j) and α(2i, 2j).

When judged “no” in STEP S402, although α(2i, 2j), which is a Lipchitz exponent of the original pixel on the right side of the interpolation pixel Q(2i−1, 2j) is already calculated, α(2i−2, 2j), which is the Lipchitz exponent of the original pixel in the left side of the Q, is not calculated. Thus, an interpolation function is selected based on the α(2i, 2j).

When judged “no” in STEP S401, it advances to a STEP S403. In STEP S403, it is evaluated whether W1(2i−2, 2j) is beyond a predetermined value. When it is beyond the predetermined value (i.e. “yes” in STEP S403), although α(2i−2, 2j), which is a Lipchitz exponent of the original pixel on the left side of the interpolation pixel Q(2i−1, 2j), is calculated, α(2i, 2j), which is a Lipchitz exponent of the original pixel on the right side is not calculated. Thus, an interpolation function is selected based on α(2i−2, 2j) (STEP S406).

When judged “no” in STEP S403, since the Lipchitz exponents of the original pixels on the right and left side of the interpolation pixel Q(2i−1, 2j) are not calculated, the Fluency function of m=4 is selected as an interpolation function (STEP S406).

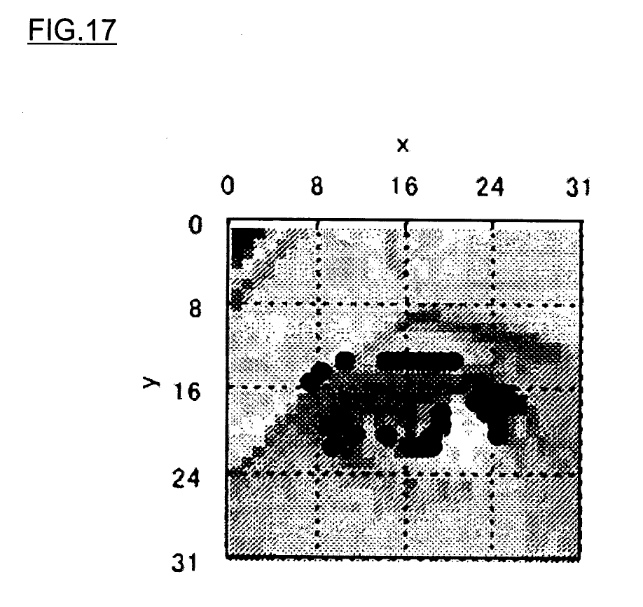

FIG. 17 shows the original pixel P(i; j), whose W1(i, j) is beyond the predetermined value. The point shown by the black dot is corresponding.

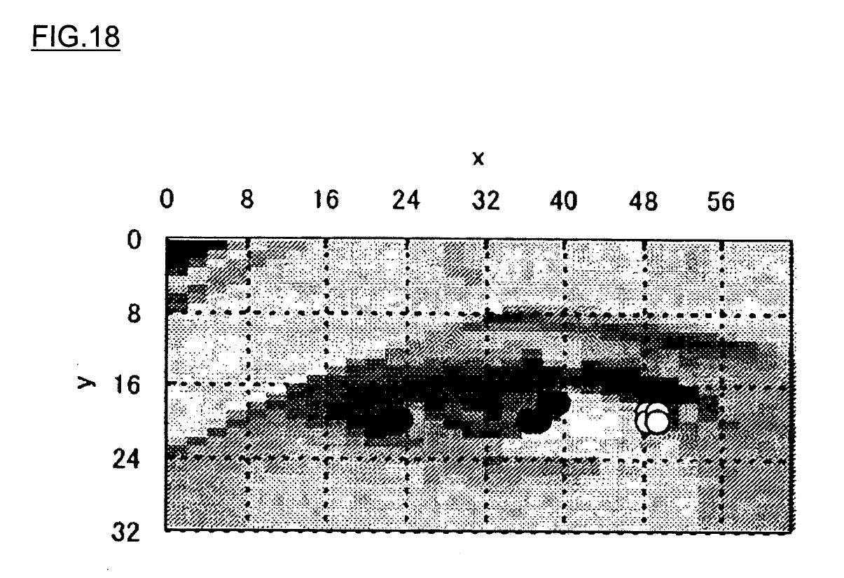

FIG. 18 shows an example of an interpolation pixel where such horizontal interpolation processing is performed. A black dot shows a generated interpolation pixel by selecting a Fluency function of m=1 in the STEP S207. A white circle shows a generated interpolation pixel by selecting a Fluency function of m=2 in the STEP S207. For a pixel without a black dot or a white circle, an interpolation pixel is generated by selecting a Fluency function of m=4.

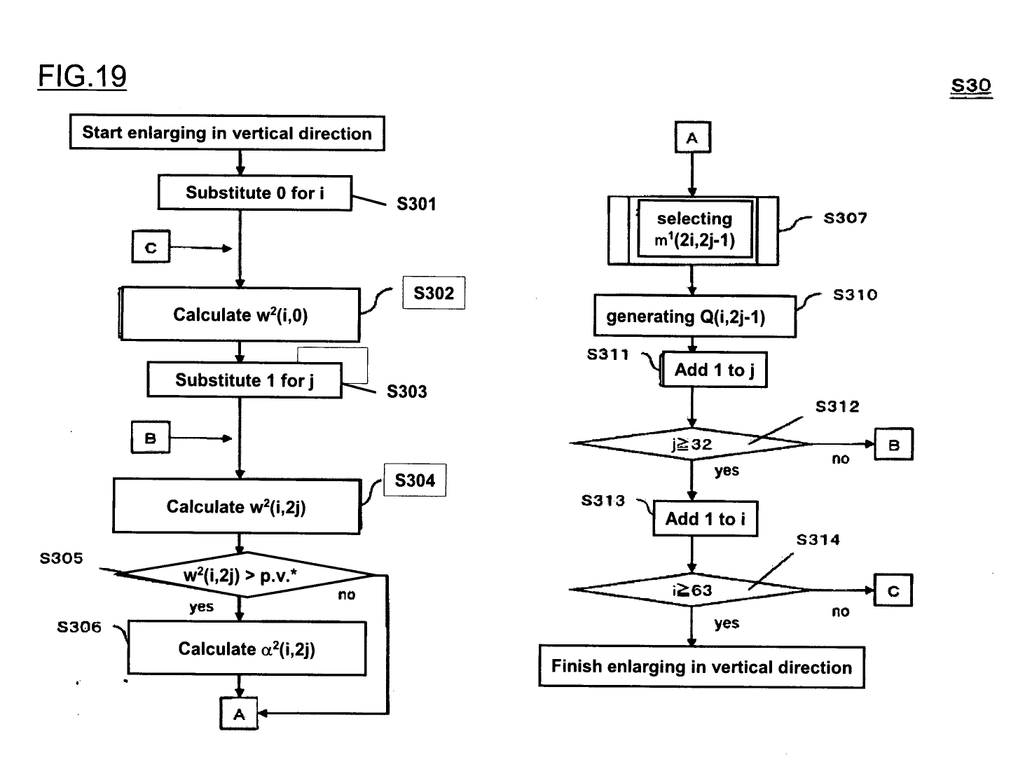

FIG. 19 is a flow chart showing a detailed procedure of an enlarging processing in the vertical direction (STEP S30). In a STEP S301, zero is substituted for i.

In a STEP S302, a vertical wavelet transform coefficient W2(i, 0) in an original pixel P(i, 0) is calculated.

In a STEP S303, 1 is substituted for j.

In a STEP S304, a vertical wavelet transform coefficient W2(i, 2j) in an original pixel P(i, 2j) is calculated. When I=0 and j=1, a vertical wavelet transform coefficient W2(0, 2) in an original pixel P(0, 2) is calculated. The original pixel P(0, 2) is an original pixel having coordinate values of x=0 and y=2. Here, W2(x, y) is acquired by setting 1 for j (scaling parameter) in the EQ.10; and it can be calculated similarly as the W1(x, y). In other words, W2(x, y) can be calculated by substituting EQ.41 in EQ.10:

$$\begin{matrix}{ψ}_{j = 1}^{2} ( x , y ) = {ϕ}_{0} ( y ) {ψ}_{1} ( x ) \\ = \frac{1}{\sqrt{π}} exp ( - {y}^{2} ) \times ( - \frac{2 x}{\sqrt{2 π}} ) exp ( - \frac{{x}^{2}}{2} )\end{matrix} \qquad [ EQ . 41 ]$$

When W2(0, 2), which can be calculated as above, is beyond a predetermined value (“yes” in STEP S305), it is regarded that there is a horizontal edge is in the position of the original pixel P(0, 2).

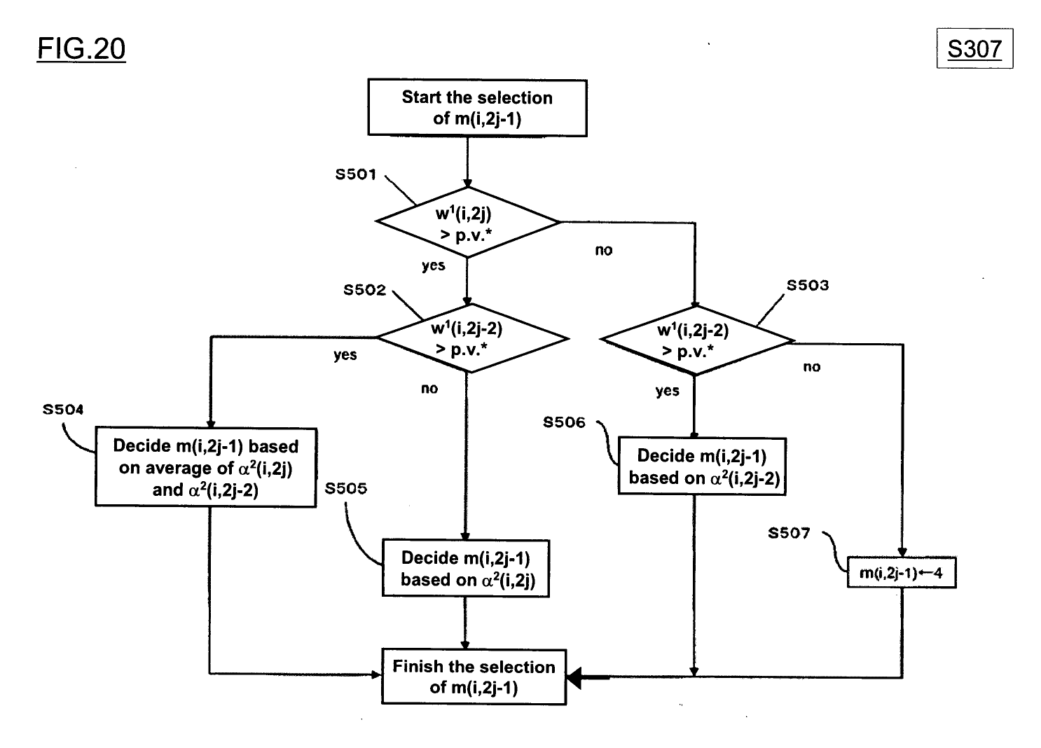

When judged “yes” in a STEP S305, a Lipchitz exponent α(0, 2) in the original pixel P(0, 2) is calculated (STEP S306). This α(0, 2) is calculated by substituting j=0 in EQ.22. In a continuing STEP S307, an interpolation Fluency function m(0, 1) for generating the luminance value of an interpolation pixel Q(0, 1), which is located in the upper side of the P(0, 2), is selected. The selection procedure of the interpolation Fluency-function is described in detail later with reference to FIG. 20.

Moreover, when judged “no” in STEP S305, STEP S306 is skipped and it advances to STEP S307.

In STEP S310, an interpolation processing in the vertical direction is performed. In other words, the luminance value of the interpolation pixel Q(0, 1) is generated based on the interpolation Fluency function m(0, 1) selected in the STEP S307 (STEP S308). Here, the interpolation pixel Q(0, 1) stands for an interpolation pixel having coordinate values of x=0 and y=1.

In a STEP S311, 1 is added to j. In a STEP S312, it is judged whether j is 32 or more. When j is less than 32 (“no” in STEP S312), it returns to S304 again. Then a wavelet transform coefficient etc. in an original pixel P(0, 4) located in the bottom side of the original pixel P(0, 2) is calculated, and the luminance value of an interpolation pixel Q(0, 3) is interpolated and generated. Then, similarly, interpolation pixel Q(0, 5), ---, Q(0, 61) of the first row are generated similarly.

When j is 32 or more (“yes” in STEP S312), it advances to a STEP S313. In STEP S313, 1 is added to i. In a STEP S314, whether i is 63 or more is judged. When i is less than 63 (“no” in STEP S314), it returns to the STEP S302. Next, interpolation pixels Q(1, 1), ---, Q(1, 61) in the second row are generated.

When i is 63 or more (“yes” in STEP S314), a series of the processing in the STEP S30 is finished.

FIG. 20 shows a procedure of selection processing of an interpolation Fluency-function in the STEP S307.

In a STEP S501, it is estimated whether W2(i, 2j) in an original pixel P(i, 2j) is beyond a predetermined value. In other words, it is judged whether a horizontal edge exists in the original pixel P(i, 2j).

In a STEP S502, it is estimated whether W2(i, 2j−2) is beyond a predetermined value. When the W2(i, 2j−2) is beyond a predetermined value (“yes” in STEP S502), an interpolation function for generating the luminance value of an interpolation pixel Q(i, 2j−1) is selected based on an average value of α(i, 2j) and α(i, 2j−2) (STEP S504).

When judged “no” in the STEP S502, although a Lipchitz exponent α(i, 2j), which is the index of an original pixel which is the lower neighbor of the interpolation pixel Q(i, 2j−1), is calculated, the Lipchitz exponent α(i, 2j−2), which is the index of an original pixel which is the upper neighbor is not calculated. Thus, an interpolation function is selected based on the α(i, 2j) (STEP S505).

When judged “no” in the STEP S501, it advances to a STEP S503. In STEP S503 it is evaluated whether W2(i, 2j−2) is beyond a predetermined value. When it is beyond the predetermined value (“yes” in STEP S503), although the Lipchitz exponent α(i, 2j−2), which is the index of an original pixel which is the upper neighbor of the interpolation pixel Q(i, 2j−1), is calculated, the Lipchitz exponent α(i, 2j), which is the index of the original pixel which is the lower neighbor is not calculated, thus an interpolation function is selected based on the α(i, 2j−2) (STEP S506).

When judged “no” in the STEP S503, neither of the Lipchitz exponents of original pixels in the upper and lower neighbors of the interpolation pixel Q(i, 2j−1) are not calculated, thus a Fluency function of m=4 is selected as an interpolation function (STEP S506).

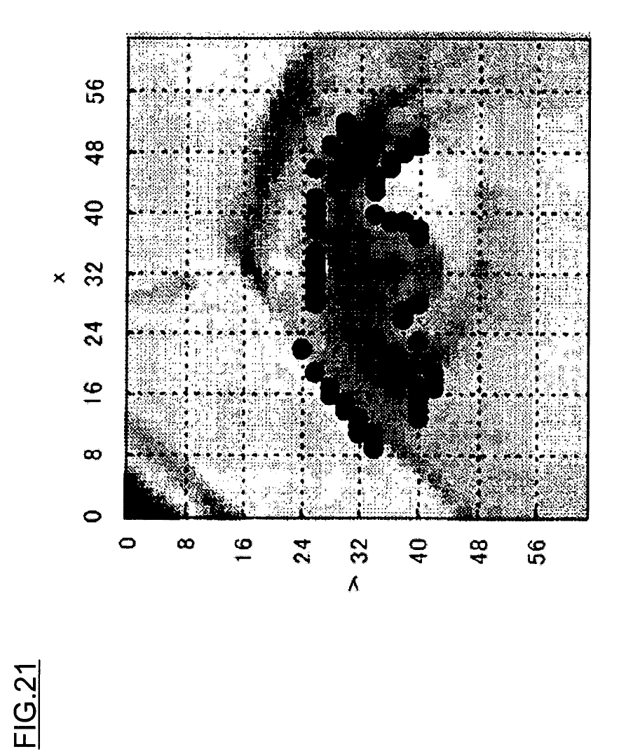

FIG. 21 shows original pixels P(i, j) whose W2(i, j) are beyond a predetermined value. The points shown by black dot correspond to the original pixels. These are the points where it is judged that a horizontal edge exists.

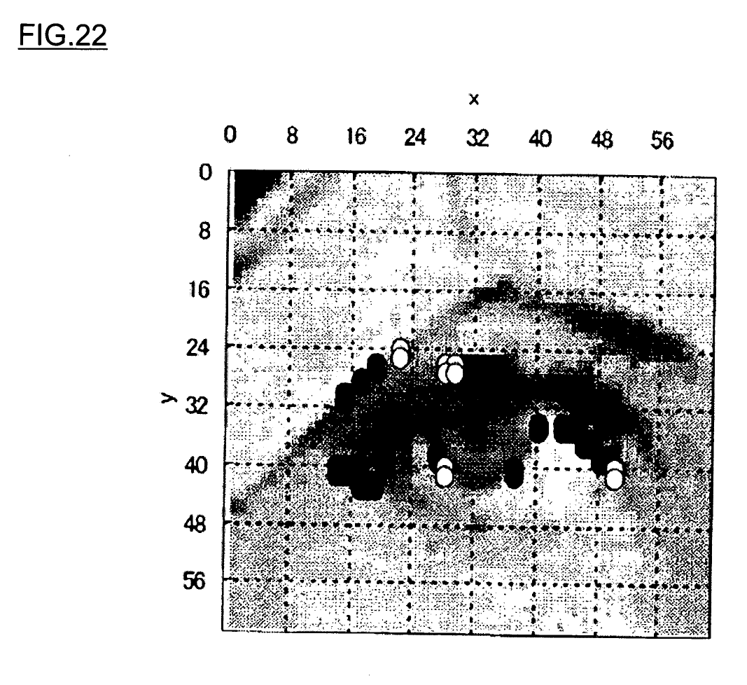

FIG. 22 shows an example of interpolation pixels where such vertical interpolation processing is performed. The black dots show the interpolation pixels which are generated by selecting a Fluency function of m=1 in the STEP S307, and the white circles show the interpolation pixels which are generated by selecting a Fluency function of m=2 in STEP S307. In the pixels without the black dot or the white circle, the interpolation pixels are generated by selecting a Fluency function of m=4.

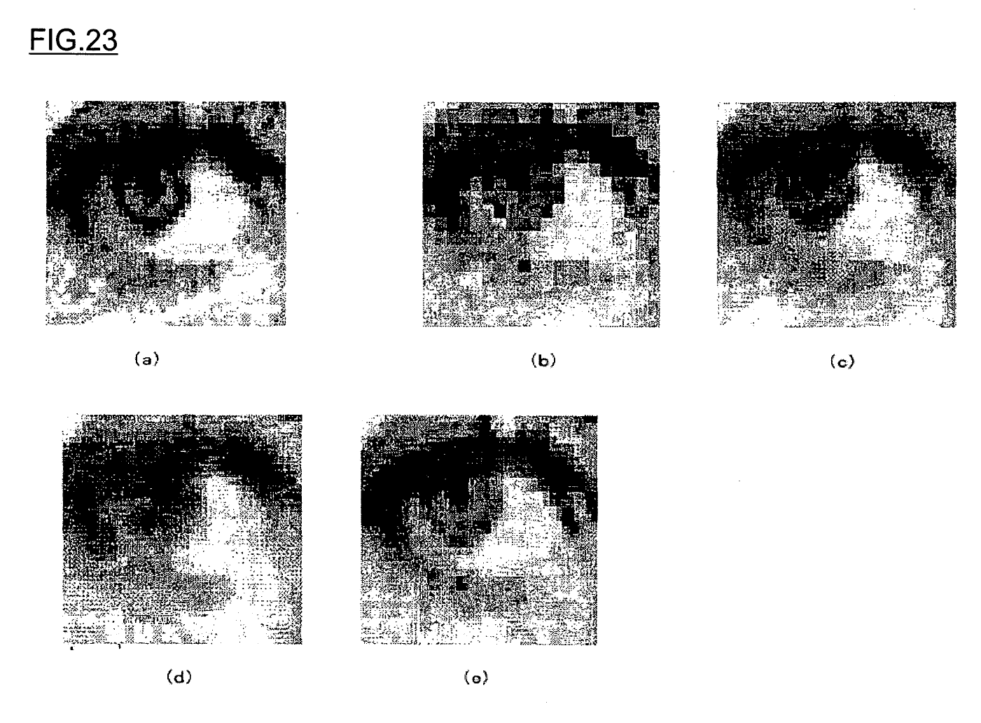

FIG. 23 shows enlarged images generated by various techniques. They are the images having 63 pixels in each vertical and horizontal direction enlarged from an original image having 32 pixels in each direction generated by the techniques of: (b) a 0th interpolation; (c) a bilinear interpolation; (d) a bicubic interpolation; (e) a present invention.

The image (a) is a high resolution image having 63 pixels in each direction, and it is not an image generated by the interpolation. According to the 0th interpolation (image (b)), although the outline of a pupil is described clearly, the center section of the pupil is coarse. According to the bilinear interpolation (image (c)), and the bicubic interpolation (image (d)), the outline of the pupil is faded. On the other hand, according to the technique of the present invention (image (e)), the outline is not faded and the smoothness is not lost in the center section.

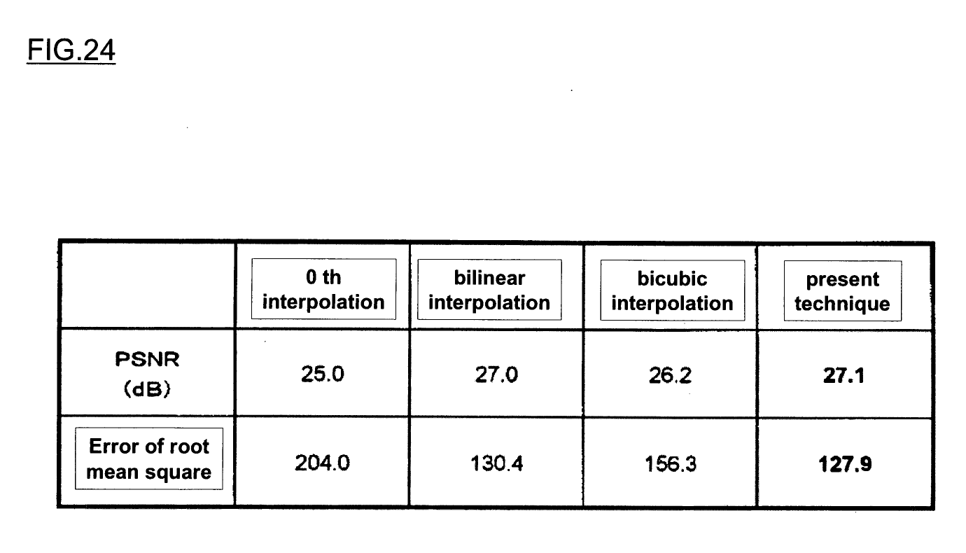

FIG. 24 shows a quality assessment result of the enlarged images generated by various techniques. Here, it is evaluated based on the PSNR (Peak Signal to Noise Ratio) and on the error of mean square with the high resolution image (image (a) in FIG. 23). As a result, both the PSNR and the error of mean square are excellent when using the present technique.

### THE SECOND EXAMPLE

In the first example mentioned above, first the enlarging processing in the horizontal direction is performed generating a temporary oblong image, and then the enlarging in the vertical direction is performed. According to this method, there is a problem that the luminance value of the interpolation pixel may not be estimated correctly, when an edge exists in the position of an interpolation pixel, and the direction of the edge is close to 45 or 135 degrees from the x-direction (horizontal direction).

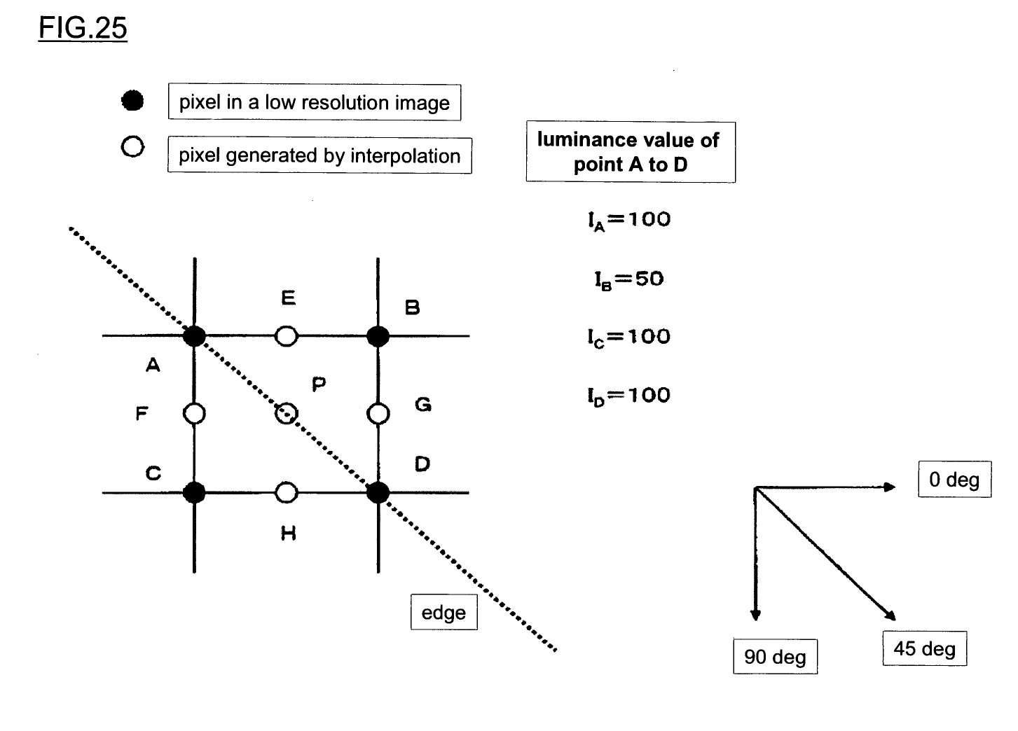

For example, assuming that pixels A, B, C, and D in an original image, which are placed as shown in FIG. 25, have luminance value of 100, 50, 100, and 100, respectively, and that an edge which crosses the pixels A and D exists. Here, generating a pixel P existing between the pixels A and D by interpolation will be explained. In other words, there is an edge having a direction of 45 degrees in the position of the pixel P

First, the luminance value of the pixels E, F, G, and H, whose luminance value are undecided, are estimated first. The luminance value of the pixel E is estimated to 75, which is an average of the luminance value of pixels A and B. The luminance value of pixel F is estimated as 100, which is an average of the luminance value of pixels A and C. The luminance value of pixel G is estimated as 75, which is an average of the luminance value of pixel B and pixel D. The luminance value of pixel H is estimated as 100, which is an average of the luminance values of pixel C and D.

In such a case, when the luminance value of pixel P is estimated as an average luminance value of pixel E and H, the value becomes 87.5. When estimated as an average luminance value of pixels F and G, the luminance value becomes 87.5 also. However, in the position of the pixel P, since there is an edge, having the direction of 45 degrees P, it may be considered that the luminance value of pixel P should be an average luminance value of pixels A and D, therefore the value should be 100.

Such problem may tend to occur especially when generating an interpolation pixel in the position of a diagonal line of original pixels.

By the method in the first example, the luminance value of the interpolation pixel is estimated based on the luminance value of the horizontal pixel or the vertical pixel only. However, considering the case such as the above, it is desirable to use the luminance value of the pixel in the diagonal direction for generating the interpolation pixel.

In the present example, first, whether an edge exists or not in each interpolation pixel position is examined. When the edge exists, then the direction of the edge is estimated by calculation. The method of interpolating is varied according to the estimated edge direction.

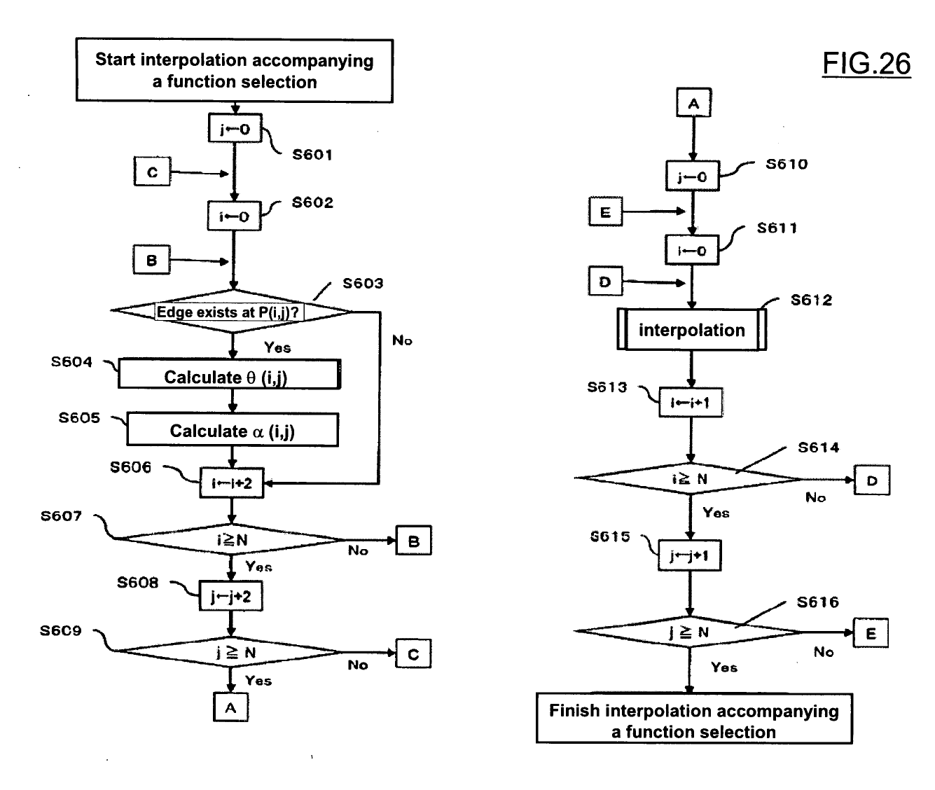

Referring to FIG. 26, the procedure of enlarging processing of the present example is explained. Here, it is a case of enlarging an original image twice. It is assumed that, as shown in FIG. 14, both the x-coordinate value and y-coordinate value of the original image are even numbers and at least one of the x-coordinate value or y-coordinate value is an odd number.

First, in a STEP S601, zero is substituted for and j, and in STEP S602, zero is substituted for i. Here, j is a variable number indicating a y-coordinate value, and i is a variable number indicating a x-coordinate value. In STEP S603, it is examined whether an edge exists in the position of an original pixel P(i, j). Here, the edge detection method can be done by any technique. The Laplacian filter may be used, or the wavelet-transform coefficient M(i, j), which is the square root of the square sum of the horizontal and vertical wavelet transform as described in EQ.15.

When it is judged in STEP S603 that an edge exists in the position of the original pixel P(i, j), the angle of the line normal to the edge θ(i, j) in the position is calculated (STEP S604). Here, θ(i, j) is described by an angle from the x-axis (the horizontal direction) in a counterclockwise rotation. For example, when θ(i, j) is zero, it means that an edge in the vertical direction exists in the original pixel P(i, j) (the line normal to the edge is in the horizontal direction). There are various method of calculating θ(i, j), for example, the angle of the line normal to the edge may be defined by the arctangent value of the ratio of the horizontal and vertical wavelet transform coefficient as described by EQ.16.

In a STEP S605, two dimensional Lipchitz exponent α(i, j) is computed using the wavelet transform coefficient M(i, j) on the original pixel.

In a STEP S606, 2 is added to i. In a STEP S607, it is examined whether i is N or more. Here, N is the total number of the pixels in horizontal direction when an original image is enlarged twice. When i is less than N, it returns to STEP S603 again. Then, the angle of the line normal to the edge and the Lipchitz exponent of the original pixel on the right side of the original pixel P are calculated (STEP S604, and STEP S605).

When i becomes N, it advances to STEP S608 and 2 is added to j. In STEP S609, it is examined whether j is M or more. Here, M is the total number of pixels in the vertical direction when the original image is enlarged in twice. When j is less than M (“no” in STEP S609), it returns to STEP S602 again, and the angle of the normal lines and the Lipchitz exponents in the original pixels in the j=2 line are calculated. When j is not less than N (“yes” in STEP S609), it advances to a STEP S610 again.

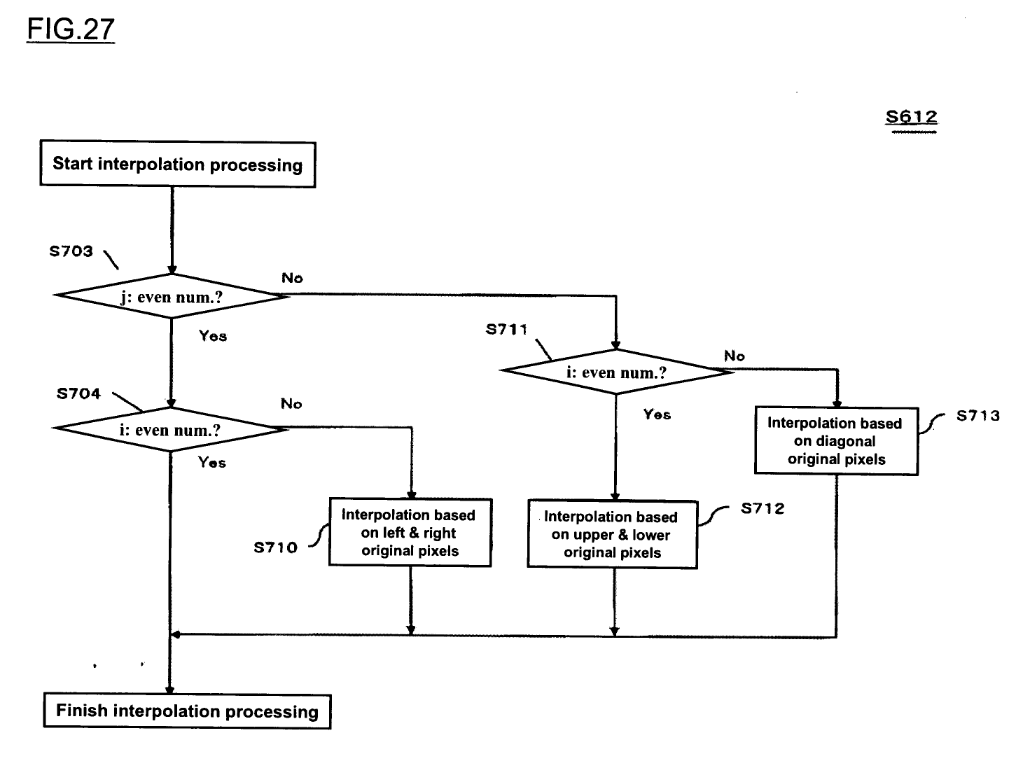

In Steps S610 from S616, the luminance value of each interpolation pixel in the interpolation image, having N by N pixels, are generated. For STEP S612, which performs an interpolation processing, is explained with reference to FIG. 27.

Referring to FIG. 27, in STEP S703, it is examined whether j is an even number, and is examined whether i is an even number in Steps S704 and S711. When the j is an even number (“yes” in STEP S703), and i is an even number (“yes” in STEP S704), since the (i, j) coordinates are the coordinates of an original pixel, it advances to a STEP S705 without performing the interpolation processing.

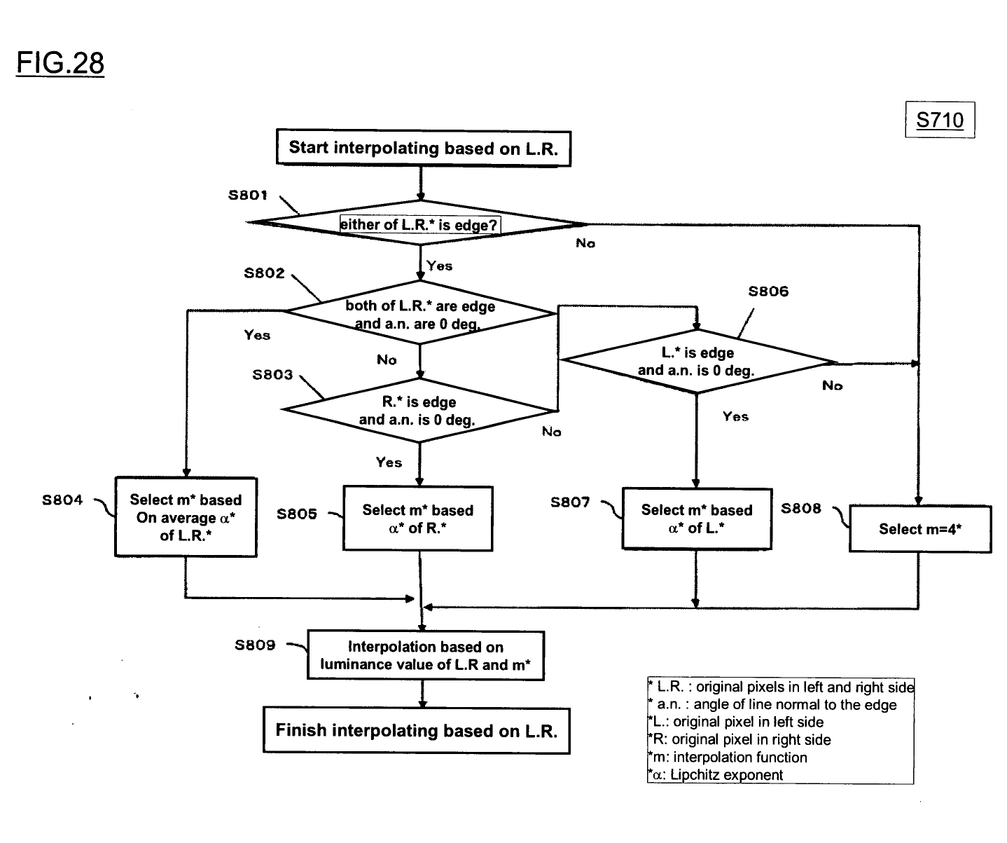

When the j is an even number (“yes” in STEP S703) and i is an odd number (“no” in STEP S704), the (i, j) coordinates are the coordinates of an interpolation pixel where original pixels exist on both the right and left sides. Therefore, the interpolation processing is performed based on the original pixels on the right and left sides (STEP S710). The processing in the STEP S710 is described in detail later with reference to FIG. 28.

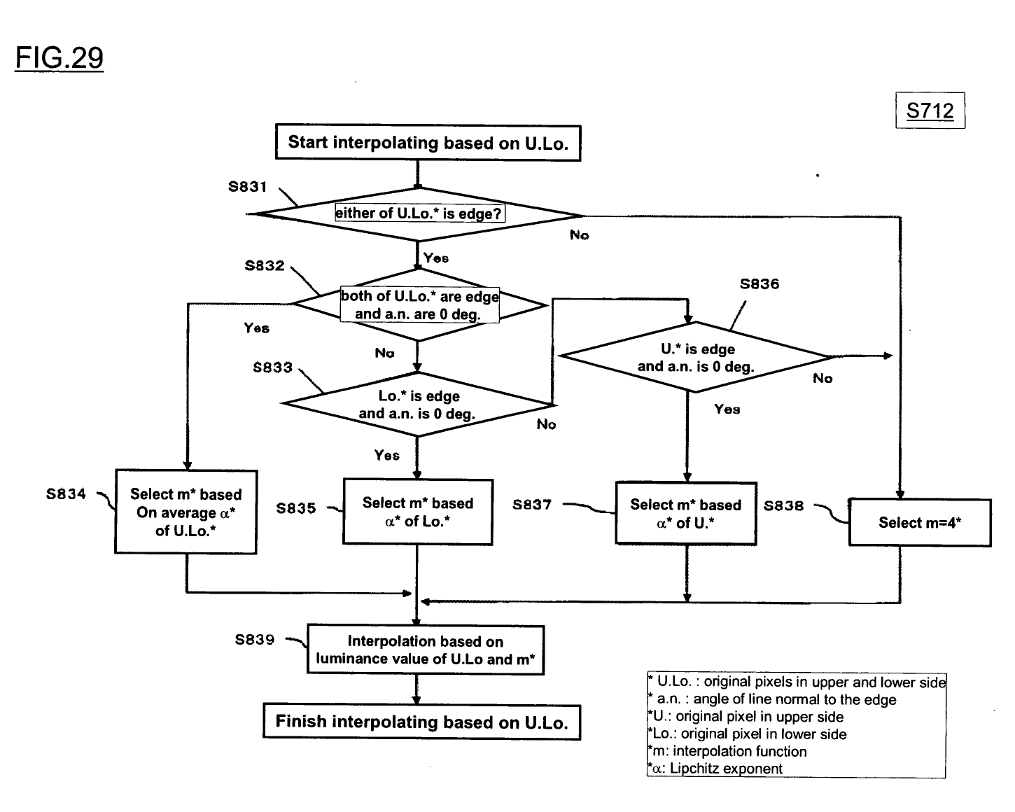

When the j is an odd number (“no” in STEP S703) and i is an even number (“yes” in STEP S711), the (i, j) coordinates are the coordinates of an interpolation pixel where the original pixels exist on both the upper and lower neighboring sides. Therefore, the interpolation processing is performed based on the original pixels on the upper and the lower neighboring sides (STEP S712). The processing in the STEP S712 is described in detail later with reference to FIG. 29.

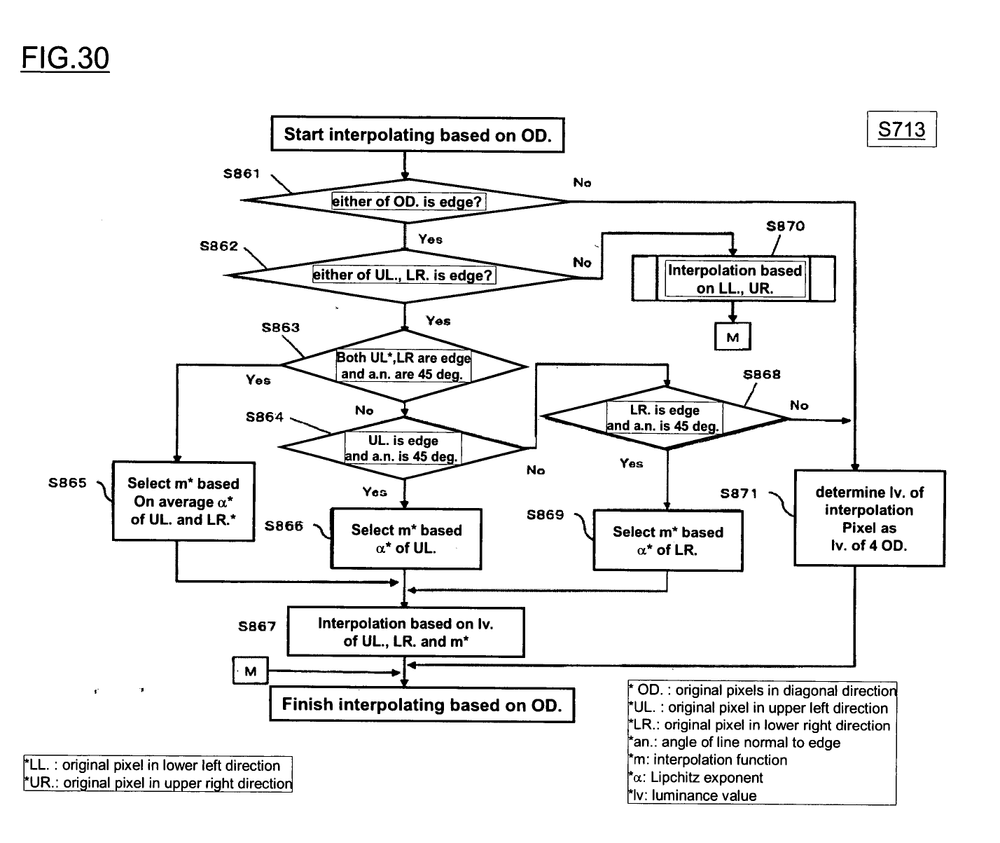

When the j is an odd number (“no” in STEP S703) and i is an odd number (“no” in STEP S711), the (i, j) coordinates are the coordinates of the interpolation pixels where the original pixels exist on the adjacent diagonal sides. Therefore, the interpolation processing is performed based on the original pixels on the adjacent diagonal sides (STEP S713). The processing in the STEP S713 is described in detail later with reference to FIG. 30.

Referring to FIG. 28, a STEP S710, performing an interpolation processing based on the original pixels on the right and left side, is explained.

In STEP S801, it is examined whether either of the original pixels on the right or left side of an interpolation pixel is an edge pixel. Here, the edge pixel means a pixel recognized as an edge in STEP S603 of FIG. 26 which is described above. When one of the original pixels on the right or left side is an edge pixel, it advances to a STEP S802.

In STEP S802, it is examined whether the right and left side pixels of an interpolation pixel are both edge pixels and whether angles of the lines normal to the edge pixels θ are both 0 degrees. Here, θ being zero degrees means that the angle of the line normal to the edge is closest to 0 degrees among 0, 45, 90, 135 degrees. When the right and left side pixels of the interpolation pixel are both edge pixels, and angle of the line normal to the edge pixels are both 0 degrees (“yes” in STEP S802), a selection of an interpolation function is performed in a STEP S804. In. STEP S804, the interpolation function is selected based on the average value of the Lipchitz exponents of the edge pixels on the right and left sides.

When judged “no” in the STEP S802, it advances to a STEP S803. In STEP S803, it is examined whether the right side pixel is an edge pixel, whose angle of the line normal to the edge θ is 0 degrees. When judged “yes” in the STEP S803, it advances to a STEP S805.

In the STEP S805, an interpolation function m is selected based on the Lipchitz exponent in the right side edge pixel.

When it is judged in STEP S803 that the right side pixel is an edge or that the right side pixel is not the edge but the normal line angle is not 0 degrees, it advances to a STEP S806.

In STEP S806, it is examined whether the left side pixel is an edge pixel, whose edge normal line is 0 degrees. When judged “yes” in STEP S806, it advances to a STEP S807. In STEP S807, an interpolation function is selected based on the Lipchitz exponent of the edge pixel on the left side.

When judged that the left side pixel is not an edge, or that the left side pixel is an edge although the angle of the normal line is not 0 degree (“no” in STEP S806), it advances to a STEP S808. In the STEP S808, an interpolation function of m=4 is selected.

In STEP S809, interpolation processing is performed, based on the luminance value of an original pixel on the right and left sides, and on the interpolation function m selected in STEPS such as S804, S805, S807, and S808.

Referring to FIG. 29, the STEP S712, which performs an interpolation processing based on the upper and the lower side original pixels, is explained.

In a STEP S831, it is examined whether either of the original pixels on the upper side or the lower side of the interpolation pixel is an edge pixel. Here, an edge pixel means that the pixel recognized as an edge in STEP S603 of FIG. 26, which is described above. When either of the upper side or the lower side original pixel is an edge pixel, it advances to a STEP S832.

In the STEP S832, it is examined whether the upper and the lower side pixels of the interpolating pixel are both edge pixels, and whether the angle of the line normal to the edge pixels θ are both 90 degrees. Here, 90 degrees means that the angle of the line normal to the edge θ is closest to 90 degrees, among 0, 45, 90, and 135 degrees. When the upper and the lower side pixels are both edge pixels, and the angles of the lines normal to the edge pixels are both 90 degrees (“yes” in STEP S832), selection of an interpolation function is performed in a STEP S834. In STEP S834, an interpolation function is selected based on an average value of Lipchitz exponents of the edge pixels on the upper and lower sides

When judged “no” in the STEP S832, it advances to a STEP S833. In STEP S833, it is examined whether the lower side pixel is an edge pixel, whose angle of the line normal to the edge is 90 degrees. When judged “yes” in the STEP S833, it advances to a STEP S835.

In the STEP S835, the interpolation function m is selected based on a Lipchitz exponent of the edge pixel on the lower side.

When judged in STEP S833, that the lower side pixel is not an edge, or that the lower side pixel is an edge but the angle of the normal line is not 90 degrees, it advances to a STEP S836.

In STEP S836, it is examined whether the upper side pixel is an edge pixel whose angle of the line normal to the edge is 90 degrees. When judged “yes” in STEP S836, it advances to a STEP S837. In STEP S837, an interpolation function is selected based on the Lipchitz exponent of the edge pixel on the upper side.

When judged that the upper side pixel is not an edge, or that the upper side pixel is an edge but the angle of the normal line is not 90 degrees (“no” in STEP S836), it advances to a STEP S838. In STEP S838, an interpolation function of m=4 is selected.

In a STEP S839, an interpolation processing is performed based on luminance values of the upper and lower side original pixel, and interpolation functions m selected in STEPS S834, S835, S837, S838 etc.

Referring to FIG. 30, STEP S713, which performs an interpolation processing based on the original pixels in the diagonal direction, is explained.

In a STEP S861, it is examined whether one of the original pixels in the diagonal direction (i.e. the upper left, the upper right, the lower left, or the lower right pixel) is an edge pixel. Here, an edge pixel means the pixel recognized as an edge in the STEP S603 of FIG. 26 described above. When one of the original pixels is an edge pixel, it advances to a STEP S862.

In the STEP S862, it is examined whether one of the original pixels on the upper left or lower right side is an edge pixel. When one of the pixels is an edge pixel (“yes” in STEP S862), it advances to S863.

In the STEP S863, it is examined whether the upper left and lower right side pixels are both edge pixels, and whether the angles of the lines normal to the edge pixels are both 45 degrees. Here, being 45 degrees means that the angle of the line normal to the edge θ is closest to 45 degrees among 0, 45, 90, 135 degrees.

When the upper left and lower right pixels are both edge pixels, and the angle of the line normal to edge pixels are both 45 degrees (“yes” in STEP S863), the selection of an interpolation function is performed in a STEP S865. In the STEP S865, the interpolation function is selected based on an average value of the Lipchitz exponents in each of the edge pixel in the upper left and lower right side.

When judged “no” in the STEP S863, in a STEP S864, it is examined whether the upper left side pixel is an edge pixel whose angle of the line normal to the edge is 45 degrees. When judged “yes” in the STEP S864, it advances to a STEP S866. In the STEP S866, an interpolation function is selected based on the Lipchitz exponent of the edge pixel on the upper left side.

When judged in the STEP S864 that the upper left pixel is not an edge pixel, or that the upper left pixel is an edge pixel but the angle of the normal line is not 45 degrees, it advances to a STEP S868.

In the STEP S868, it is examined whether the lower right pixel is an edge pixel whose direction of the line normal to the edge θ is in 45 degrees. When judged “yes” in the STEP S868, it advances to a STEP S869. In the STEP S869, an interpolation function is selected based on the Lipchitz exponent of an edge pixel on the lower right side.

When the angle of the normal line angle of the edge pixel on the lower right side is not 45 degrees (“no” in STEP S868), it advances to a STEP S871. In the STEP S871, an average value of the luminance value of the 4 pixels, i.e. pixels on the upper left, the lower right, the upper right, and the lower left side, is determined to be a luminance value of the interpolation pixel.

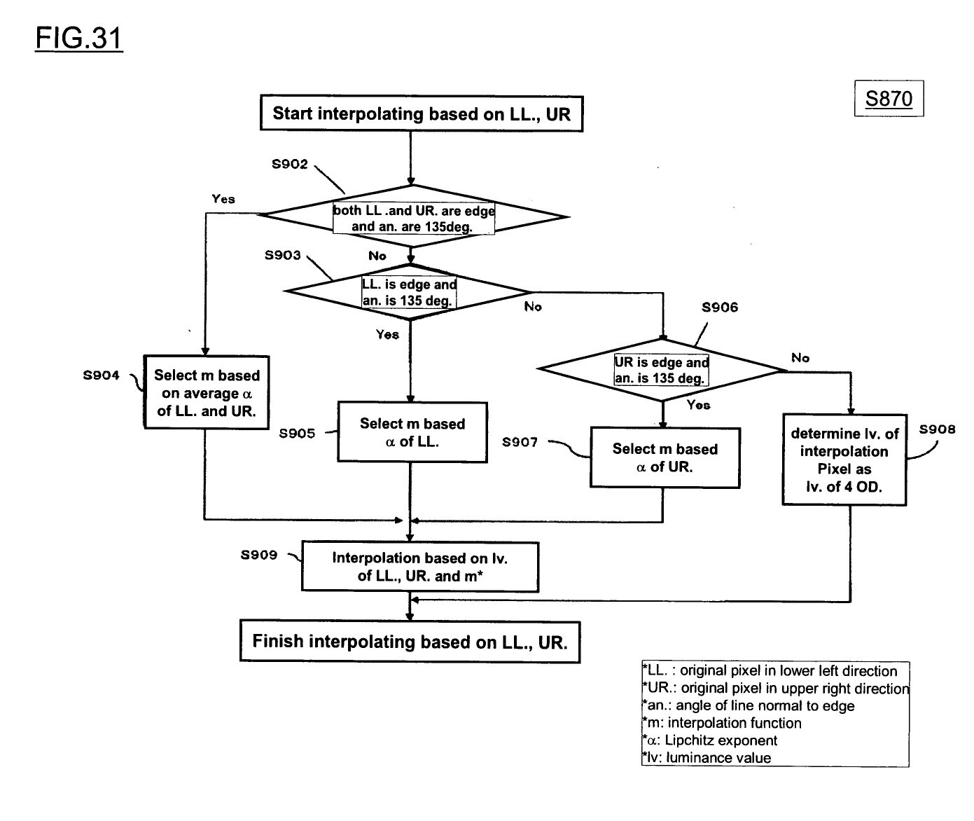

When judged in the STEP S862 that none of the pixels on the upper left or lower right sides is not an edge pixel, it advances to a STEP S870, which performs an interpolation processing based on the original pixel in the lower left and upper right sides. The processing in the STEP S870 is explained in detail later with reference to FIG. 31.

In a STEP S867, an interpolation processing is performed based on luminance value of the original pixels on the upper left and lower right side, and the interpolation functions m selected in STEPS S865, S866, and S869 etc. Referring to FIG. 31, the STEP S870, which performs an interpolation processing based on the original pixel on the lower left and upper right side, is described.

In STEP S902, it is examined whether the pixels in the lower left and upper right sides of the interpolation pixel are the both edge pixels, and whether the angles of the lines normal to the edge pixels θ are both 135 degrees. Here, being 135 degrees means that the angle of the line normal to the edge θ is closest to 135 degrees, among 0, 45, 90, and 135 degrees.

When both the pixels on the lower left and upper right side of an interpolation pixel are edge pixels and both of the angles of the lines normal to the edge pixels are 135 degrees (yes in STEP S902), selection of an interpolation function is performed in a STEP S904. In STEP S904, the interpolation function is selected based on an average value of Lipchitz exponents of the edge pixel on the lower left and upper right side.

When judged “no” in the STEP S902, in a STEP S903, it is examined whether the pixel on the lower left side is an edge pixel whose angle of the line normal to the edge is 135 degrees. When judged “yes” in the STEP S903, it advances to a STEP S905. In the STEP S905, an interpolation function is selected based on the Lipchitz exponent of the edge pixel on the lower left side.

When it is judged in STEP S903 that the pixel on the lower left side is not an edge pixel, or that pixel on the lower left side is an edge pixel but the normal line angle is not 135 degrees, it advances to a STEP S906.

In a STEP S906, it is examined whether the upper right side pixel is an edge pixel, whose angle of the line normal to the edge θ is 135 degrees. When judged “yes” in STEP S906, it advances to a STEP S907. In the STEP S907, an interpolation function is selected based on the Lipchitz exponent of the edge pixel on the upper right side.

When it is judged in STEP S906, that the upper right side pixel is not an edge pixel, or that the upper right side pixel is an edge pixel but the angle of the normal line is not 135 degrees, it advances to a STEP S908.

In the STEP S908, an average of luminance values of 4 pixels, i e. the pixels on the upper left, the lower right, the upper right, and the lower left side, is determined as the luminance value of the interpolation pixel.

In a STEP S909, an interpolation processing is performed based on luminance values of original pixels on the lower left and upper right side, and on interpolation functions m selected in STEPS S904, S905, and S907 etc.

According to an image enlarging device described above, the function used for interpolation is determined based on the estimated number of continuously differentiable times of the image in local image using the wavelet transform. Therefore, the device has the following advantages: (1) It can perform an image enlarging with a small amount of data processing; (2) It can perform an image enlarging according to the feature of the images.

The embodiments described above are examples, and it should not be considered as limiting the invention set forth in the appended claims. The scope of the present invention is shown by the claim, not by the above mentioned embodiments, and it is intended to include the equivalent of the scope of the claim, and is intended to include all modification within the scope of the claim.

1. An image enlarging device, for acquiring an image data of an enlarged image by setting the luminance value of an interpolation pixel from the pixel value of an original image data, comprising:
a detection means for detecting an edge position in the original image data;
an estimation means for estimating a number of continuously differentiable times at the edge position detected in the detection means;
a selection means for selecting an interpolation function based on the number of continuously differentiable times estimated in the estimation means;
an interpolation means for performing a pixel interpolation processing in an edge area based on the interpolation function selected in the selection means.

2. The image enlarging device of claim 1, wherein, the estimation means estimates the number of continuously differentiable times based on a Lipchitz exponent of the edge position.

3. An image enlarging device, for acquiring an image data of an enlarged image by setting the luminance value of an interpolation pixel from the pixel value of an original image data, comprising:
a detection means for detecting an edge position in the original image data;
an operation means for calculating a Lipchitz exponent of the edge position detected in the detection means;
a selection means for selecting an interpolation function based on the Lipchitz exponent calculated in the operation means;
an interpolation means for performing a pixel interpolation processing in an edge area based on the interpolation function selected in the selection means.

4. The image enlarging device of claim 1, wherein the interpolation function is a Fluency function.

5. The image enlarging device of claim 1, wherein the selection means selects the interpolation function based on whether the angle of the line normal to the edge is closest to 0, 45, 90, or 135 degrees.

6. The image enlarging device of claim 5, wherein,
when the interpolation pixel is sandwiched by original pixels on a right and left sides, and an edge exists in any of these original pixels, the selection means selects the interpolation function based on the number of continuously differentiable times or the Lipchitz exponent in these original pixels, when the normal line angle of the edge is closest to 0 degrees;
when the interpolation pixel is sandwiched by original pixels on an upper and lower sides, and an edge exists in any of these original pixels, the selection means selects the interpolation function based on the number of continuously differentiable times or the Lipchitz exponent in these original pixels, when the normal line angle of the edge is closest to 90 degrees;
when the interpolation pixel is sandwiched by original pixels on a 45 degrees diagonal sides, and an edge exists in any of these original pixels, the selection means selects the interpolation function based on the number of continuously differentiable times or the Lipchitz exponent in these original pixel, when the normal line angle of the edge is closest to 135 degrees; and
when the interpolation pixel is sandwiched by original pixels on a 135 degrees diagonal sides, and an edge exists in any of these original pixels, the selection means selects the interpolation function based on the number of continuously differentiable times or the Lipchitz exponent in these original pixel, when the normal line angle of the edge is closest to 45 degrees.

7. The image enlarging device of claim 1, wherein the interpolation means selects a pixel to refer for the interpolation processing, according to the direction of the original pixels sandwiching the interpolating pixel.

8. The image enlarging device of claim 7, wherein,
when the interpolation pixel is sandwiched by original pixels on the right and left hand directions, the interpolation means performs the interpolation processing referring to the original pixels on the right and left sides;
when the interpolation pixel is sandwiched by original pixels on the upper and lower hand directions, the interpolation means performs the interpolation processing referring to the original pixels on the upper and the lower sides; and
when the interpolation pixel is sandwiched by original pixels on the 45 or 135 degrees diagonal sides, the interpolation means performs the interpolation processing referring to the original pixels on the 45 or 135 degrees diagonal sides.

9. A computer program usable with a programmable computer having a computer readable program code embodied therein, said computer readable program code comprising computer program code for executing the steps of:
an edge detecting step for detecting an edge position from a digital image data;
an estimating step for estimating a number of continuously differentiable times at the edge position detected in the edge detecting step;
a selecting step for selecting the interpolation function based on the number of continuously differentiable times estimated in the estimating step;
and an interpolating step for performing a pixel interpolation processing in an edge area based on the interpolation function selected in the selecting step.

10. The computer program product of claim 9, wherein, the number of continuously differentiable times is estimated based on a Lipchitz exponent of the edge position in the estimating feature.

11. A computer program product usable with a programmable computer having a computer readable program code embodied therein, said computer readable program code comprising computer program code for executing the steps of:
an edge detecting step for detecting an edge position from a digital image data;
an operating step for calculating a Lipchitz exponent at the edge position detected in the edge detecting step;
a selecting feature for selecting the interpolation function based on the Lipchitz exponent estimated in the estimating step; and
an interpolating step for performing a pixel interpolation processing in an edge area based on the interpolation function selected in the selecting step.

12. The computer program product of claim 9, wherein the interpolation function is a Fluency function.

13. The computer program product of claim 9, wherein the interpolation function is selected based on whether the normal line angle of the edge is the closest to 0, 45, 90, or 135 degrees in the selecting step.

14. The computer program product of claim 13, wherein,
when the interpolation pixel is sandwiched by original pixels on the right and left sides, and an edge exists in any of these original pixels, the interpolation function is selected based on the number of continuously differentiable times or the Lipchitz exponent in these original pixels, when the normal line angle of the edge is closest to 0 degrees in the selecting step;
when the interpolation pixel is sandwiched by original pixels on the upper and lower sides, and an edge exists in any of these original pixels, the interpolation function is selected based on the number of continuously differentiable times or the Lipchitz exponent in these original pixels, when the normal line angle of the edge is closest to 90 degrees in the selecting step;
when the interpolation pixel is sandwiched by original pixels on the 45 degrees diagonal side, and an edge exists in any of these original pixels, the interpolation function is selected based on the number of continuously differentiable times or the Lipchitz exponent in these original pixels, when the normal line angle of the edge is closest to 135 degrees in the selecting step;
when the interpolation pixel is sandwiched by original pixels on the 135 degrees diagonal side, and an edge exists in any of these original pixels, the interpolation function is selected based on the number of continuously differentiable times or the Lipchitz exponent in these original pixels, when the normal line angle of the edge is closest to 45 degrees in the selecting step.

15. The computer program product of claim 9, wherein the referring pixel for an interpolation processing is selected according to the direction of the original pixels sandwiching the interpolation pixel in the interpolating step.

16. The computer program product of claim 15, wherein,
when the interpolation pixel is sandwiched by original pixels on a right and left sides, the interpolation processing is performed referring to the original pixels on the right and left sides in the interpolating step,
when the interpolation pixel is sandwiched by original pixels on an upper and lower sides, the interpolation processing is performed referring to the original pixels on the upper and lower sides in the interpolating step,
when the interpolation pixel is sandwiched by original pixels on an diagonal side, the interpolation processing is performed referring to the original pixels on the diagonal side in the interpolating step.
